(19) United States
(12) Patent Application Publication
(10) Pub. No.: US 2006/0059265 A1
(43) Pub. Date: Mar. 16, 2006

(54) Terminal connectivity system

(76) Inventor: Seppo Keronen, Chatswood (AU)

Correspondence Address: RANKIN, HILL, PORTER & CLARK LLP, 4080 ERIE STREET, WILLOUGHBY, OH, 44094-7836, US

(21) Appl. No.: 10/525,605

(22) PCT Filed: Jun. 17, 2003
(86) PCT No.: PCT/CH03/00393

§ 371 Date: Apr. 15, 2005

(30) Foreign Application Priority Data
Aug. 27, 2002 (AU) 200295103

(51) Int. Cl. G06F 15/16

(52) U.S. Cl. 709/228

(57) ABSTRACT

The present invention provides a Server (1) for allowing a user to connect to services using a remote terminal (“Host A”,3. “Host B”). The Server is coupled to the remote terminal via one of a number of communications links (4,5,2), as well as being coupled to the one or more services in use (4A). The Server generally includes a store for storing device data including an identifier for each of a number of terminals authorised to access the remote services. This is used by an authentication system which obtains an identifier from the terminal, compares this with the device data and establishes a connection in response to the successful comparison. The Server also includes a cache store for storing data transmitted to and received from the terminal. A switching system is used to determine if an alternative connection can be established via one or more alternative communications links, compare the alternative connection to the existing connection and, establish the alternative connection in response to a successful comparison. The Server also includes a security system (1A) which encodes data to be transmitted to the terminal in accordance with the data stored in the cache store and decoding data received from the terminal in accordance with the data stored in the cache store.

### BACKGROUND OF THE INVENTION

The present invention relates to a Server, a terminal, a system and a method for allowing a user to connect to services using a remote terminal according to the patent claims.

### DESCRIPTION OF THE PRIOR ART

The reference to any prior art in this specification is not, and should not be taken as, an acknowledgement or any form of suggestion that the prior art forms part of the common general knowledge.

Currently many data communications access networks are available, with many more are under construction and planned for the future. These access networks provide the means for terminal devices to access data services hosted on the public internet and private intranet networks. Examples of terminal devices are notebook computers, tablet or notepad computers, personal digital assistant (PDA) devices and smart cellular phones. Examples of data services access methods and apparatus using access networks are telephone modem and DSL modem access via the public switched telephone network, cable modem access via coaxial and fibre cable networks, GSM/GPRS access via a cellular mobile telephone network and wireless modem access via an IEEE 802.11 wireless LAN access point.

Many access networks allow internet protocol (IP) data packets to be routed to the global internet infrastructure, which in turn is designed to route the packets to any desired internet host address. Furthermore, many private networks or intranets are connected to the internet by means of a firewall host computer. The firewall is designed to protect the privacy and functionality of the private intranet.

The infrastructure, described above, consisting of access networks, the public internet and private intranets, provide the basic means for terminal devices connected to the infrastructure to access data services hosted on server computers or peer terminal devices connected to the infrastructure.

However, existing systems tend to suffer a number of drawbacks and will now be highlighted with reference to the example system shown in FIG. 1.

In this example, a terminal 103 is adapted to be coupled to either of two server 101, via the Internet 102 and an access network 104. One of the servers 101 is protected by a firewall 105, and is connected to the intranet 106. The connection between the terminal and the servers are formed as tunnel connections 107.

In this case, three separate data service access pathways are illustrated for accessing host services including:
Host A: The terminal 103 communicates with host computer A by means of an ordinary TCP/IP protocol connection or connectionless UDP/IP. The data communication packets are routed via an access network and intranet. Typically the computer hosting the service being accessed is connected to the internet via a high bandwidth access network. The illustrations in this document omit such details for clarity of explanation.
Host B: The terminal 103 communicates with host computer B by means of a secure data communications protocol, such as IPSec or one of the many proprietary virtual private network (VPN) protocols available or any other secure data communication channel. Typically these protocols encapsulate IP protocol packets, hence the term tunnelled connection is often used to refer to such secure connections.
Host C: The terminal 103 communicates with host computer C located on a private intranet. The communications pathway is divided into a secured segment across the public networks and an unsecured segment across the intranet. This method enables the private data services hosted on an intranet to be accesses via insecure public networks.

There are several problems with the architecture illustrated in FIG. 1, including security, operating cost and connectivity problems.

The security requirements for access to private services typically include the need to authenticate both the service client and the service provider in order to prevent access by unauthorised parties. Confidential information should not be available to unintended third parties. It is also typically required to keep verifiable account information of service access. Service availability should be ensured as far as possible, even under malicious service denial attacks.

Problems include:

Service Context Authentication:

Providing access only in specific circumstances, such as:
User Authentication: Access is only granted to a specific user, or in the presence of user or group of users.
Device Authentication: It may be required that the terminal device and the service server are mutually authenticated.
Location Authentication: Specific services may only be available to terminals located at specific geographic locations.
Application Authentication: Malicious, faulty or incompatible software installed on an otherwise authorized terminal or server can present a security and service quality threat. Hence the presence of authorized software and absence of unauthorized software is often required.
   Transport Security:

Data packets traversing a public access network and the internet are subject to interception and falsification. Interception by unauthorised parties presents an information privacy threat. Falsification of data packets presents privacy, service theft and service denial threats. For these reasons it is necessary to ensure that intercepted data packets do not reveal private information to unauthorised parties, and to ensure that data packets that are injected into the network by unauthorised parties are detected and rejected.

File System Privacy:

In the case that either the terminal device or server device falls into the hands of unauthorised parties, any sensitive information stored on storage devices, such as disk drives, should be protected.

Non-Repudiation:

It may be required to keep a verifiable record of communications between terminals and a server. Such a record may be used to resolve any disputes arising between the service provider and service consumer.

Operating Cost Problems Include:

High Cost:

Many access networks charge for network traffic based on traffic volume or simple time, being even multiplied by used channels per time. Such charges are particularly high for wireless networks that employ licensed radio spectrum. These costs need to be minimised.

Cost Management and Auditing:

It is often necessary to attribute costs to specific users or applications. Such information is typically used to manage costs and minimise future costs of operation and this is not typically available in most existing products. In order to eliminate disputes, verifiable records of network traffic may need to be available.

System Capacity Planning:

As more users drive more traffic, connection bandwidth and data processing capacity need to be increased to meet the increased demand. Also if demand decreases, cost savings may be possible by downsizing bandwidth and processing capacity. It is necessary to keep track of trends that indicate changed demand.

Connectivity Related Problems Include:

Long Latency:

Networks often employ a limited region of radio spectrum to offer a shared communications service to many clients. Contention for access to the shared communications medium means that long delays may occur between the time that the transfer of data is requested and the time when that transfer can actually take place. Applications that operate via such networks need to provide a responsive user experience, despite such adverse circumstances.

Network Coverage:

Wireless networks typically do not provide a uniform quality of coverage for an entire geographic region where access to the network is needed. There are often low signal strength, low signal quality areas and low quality of services, where the service bandwidth or reliability is reduced or where service is not available at all. Applications that are accessed via such networks need to operate as reliably as possible, despite such adverse circumstances, with little being provided in the prior art to address these issues.

Dial Up Problems

Often there is the problem to find the local and most cost effective Internet Service Provider where ever in the world the terminal user is. And even worse not all providers deliver the same set of supported services, caused by different local operator quality of service parameters.

Terminal Visibility:

Wireless and wired access networks often provide private internet protocol (IP) addresses, which are not visible to hosts on the internet. In this case an internet host, is not able to establish a connection to the terminal. This functional deficiency means that applications that require the connection to be established by a server or peer to the terminal cannot be used.

Multiple Networks Problem:

More than one access network may be available at any one time or over a period of time. For example, the terminal may be able to communicate via a GPRS cellular network, a wireless LAN network and a fixed line Ethernet LAN. Where multiple access networks are available at the one time or as availability of access networks changes over time, the terminal user is currently called on to manually select which network is actually used, which can result in inefficient network usage.

A number of product distribution related problems also exist such as the fact that many existing systems are complex and solutions often consist of many products each with many sub-components. A simple to deploy product that offers the whole solution to a data communication need is difficult to achieve.

Furthermore, data communications products that consist of two apparatus parts, a terminal and a server, typically require a wide deployment of the server component before the terminal component is sufficiently useful. This requirement makes the economic deployment of such products difficult.

### SUMMARY OF THE PRESENT INVENTION

The general idea of the invention aims to realize a service server that realizes the criteria of Security/Encryption, User data persistence, Traffic redirection, Tunnelling, Authentication and Cashing and, therefore, will be named as SUTTAC-Server hereinafter. According to the invention such SUTTAC-Server will act as special gateway device(s) (not in the sense of common known network gateways according to the prior art) to provide onward connectivity of one or more remote terminal(s) to the one or more services in use.

In a first broad form the present invention provides an active interface for allowing a user to connect to services of a SUTTAC-Server using a remote terminal, the active interface being coupled to the remote terminal via one of a number of communications links and to the one or more services in use, the active interface including:
a) A store for storing device data, the device data including an indication of an identifier for each of a number of predetermined terminals authorised to access the remote services;
b) An authentication system, the authentication system being adapted to:
   (i) Obtain an identifier from the terminal; and,
   (ii) Compare the identifier of the terminal to the device data; and,
   (iii) Establish a connection between the active interface and the terminal via at least one of the communication links, in response to the successful comparison;
c) A (bidirectional) cache store including:
   (i) A first cache adapted to store data transmitted to the terminal; and,
   (ii) A second cache adapted to store data received from the terminal; and,
d) A switching system, the switching system being adapted to:
   (i) Receive an alternative connection request from the terminal, the alternative connection request indicating that an alternative connection is to be established; and,
   (ii) Cooperate with the terminal to establish the alternative connection in response to the request;
e) A security system, preferably combined with a compression system, the system being adapted to perform at least one of
   (i) Encoding and/or compressing data to be transmitted to the terminal in accordance with the data stored in the cache; and,
   (ii) Decoding and/or decompressing data received from the terminal in accordance with the data stored in the cache.

The system can be adapted to encode data by a compression mechanism with subsequent encryption and on the receiver's side with a corresponding mechanism that decodes data by decrypting and subsequent decompression of data.

The terminal typically has a corresponding cache store, the corresponding cache store being adapted to be identical or, in special embodiments, logically linked to the Server cache store.

Each cache and corresponding cache is typically adapted to store predetermined secret data.

The system may be adapted to compress the data to be transferred by:
a) Comparing the data to be transferred to the data stored in the first cache; and,
b) Determining matching data in accordance with the results of the comparison;
c) Modifying the data to be transmitted by replacing the matching data with a cache reference, the terminal being adapted to be responsive to the transmitted data to replace the cache references with the matching data from the corresponding first cache.

In addition the system can be adapted to decompress data received from the terminal by:
a) Locating cache references in the received data, the cache references being generated by the terminal in accordance with data contained in the corresponding second cache;
b) Accessing the data stored in the second cache;
c) Modifying the received data by replacing the cache references with matching data with a cache store reference, the terminal including a corresponding cache store and being adapted to be responsive to the transmitted data to replace the cache store references with the matching data from the corresponding cache store.

A preferred security system can be adapted to encrypt/decrypt data the data to be transferred by
a) Generating an encryption/decryption factor in accordance with the selected data stored in the cache store; and,
b) Encrypting/decrypting the compressed data in accordance with the generated encryption/decryption factor.

The encryption/decryption factor can be preferably based on a checksum of the data contained in the first/second cache, although any suitable factor may be used. The encryption/decryption factor may be used to generate an encryption/decryption key, the key being used in an encryption/decryption algorithm.

The cache store system can be adapted to select the transmitted data to be stored. Furthermore, the cache store system can be adapted to select the data in accordance with at least one of a number of criteria including:
a) Transparent redirection and destination address based compression with possibility to use wildcards
b) Transmission frequency of the data;
c) The communications link used to transmit the data;
d) The data volume;
e) Any quality of service (QOS) requirements for the data transmission; and,
f) Any priority requirements for the data transmission.

According to the invention, connections are split by two groups: LAN and RAS. Wired Ethernet and WiFi connection belong to LAN, while GPRS, GSM and modem connection are in RAS group (RAS connection are always dial-up connections). Then these connections in each group may be differentiated by keywords in adapter/connection names. Thus, typically four groups and four accounting types may be identified:
Wired LAN—Fixed fee/Free of charge
WiFi LAN—Traffic based/Time based
GPRS—Traffic based/Fixed Fee
Dial-up—Time based

The connections links typically include at least one of:
a) An Internet connection.
b) A cellular connection;
c) A short range wireless connection;
d) A LAN connection; and,
e) A fixed line/wired connection

At least one of the communications links may be established as a tunnel connection with the terminal, although other alternative secure tunnel connections may also be used.

The store can be adapted to store user data, the user data including a user identifier for each user authorised to access the remote services, the authentication system being adapted to:
a) Receive a user identifier from the terminal;
b) Compare the user identifier to the user data; and,
c) Establish the connection in response to a successful comparison.

The unique identifier may preferably be a username and password. A further feature of the invention foresees an authentication system with a switching system that provide one time authentication such that the unique identifier is not required when an alternative connection is to be established. A secure (VPN) account may be authenticated separately. However, in an alternative embodiment, the system may require authentication each time an alternative link is established.

The cache store can include a number of first and second caches, at least one respective first and second cache being used for each terminal adapted to be connected to the SUTTAC-Server. In this context “store” will not only refer to a database (DB) nor to plain file(s) but rather should be any method or storage that provides persistence to some data. Typically, on the server side these are DB and cache files. On the client side these are cache files, registry and some in-memory structures (which are not persistent but used for interprocess communications (IPC)). These first and second caches may be used for different data types. The SUTTAC-Server furthermore can include a converter, the converter being adapted to receive data having a first form and output data having a second form. The converter may be accepted to receive data from the Internet and transfer the data to the terminal, e.g. UDP data will be converted to TCP data.

The switching system can be adapted to:
a) Detect failure of the established connection between the SUTTAC-Server and the terminal; and,
b) Maintain any links between the SUTTAC-Server and respective services in communication with the terminal until the connection is restored.

The active interface may include a processor, the processor being adapted to implement at least one of:
a) The authentication system;
b) The switching system; or,
c) The security system.

The services may include:
a) Access to one or more processing systems;
b) Access to one or more communications networks;
c) Access to one or more databases; and,
d) The Internet.

In a second broad form the present invention provides a terminal adapted to communicate with a SUTTAC-Server for allowing a user to connect to services, the terminal being coupled to the SUTTAC-Server via one of a number of communications links and to the one or more services in use, the terminal including:
a) A store for storing device data, the device data including an indication of an identifier for the terminal;
b) An authentication system, the authentication system being adapted to:
   (i) Generate an identifier in accordance with the device data; and,
   (ii) Transfer the identifier to the SUTTAC-Server, the SUTTAC-Server responding to the identifier to determine if the terminal is authorised to access the remote services and, establish a connection between the SUTTAC-Server and the terminal via at least one of the communication links, in response to the successful determination;
c) A cache store including:
   (i) A first cache adapted to store data transmitted to the terminal; and,
   (ii) A second cache adapted to store data received from the terminal;
d) A switching system, the switching system being adapted to:
   (i) Determine if an alternative connection can be established via one or more alternative communications links;
   (ii) Compare the alternative connection to the existing connection; and,
   (iii) Transfer an alternative connection request to the SUTTAC-Server;
   (iv) Cooperate with the SUTTAC-Server to establish the alternative connection; and,
e) A security system, the security system being adapted to perform at least one of
   (i) Encoding data to be transmitted to the SUTTAC-Server in accordance with the data stored in the cache store; and,
   (ii) Decoding data received from the SUTTAC-Server in accordance with the data stored in the cache store.

The terminal is preferably adapted to communicate with the SUTTAC-Server of any one of the first broad form of the invention.

The SUTTAC-Server can have a corresponding cache store to the one of the terminal, the corresponding cache store being adapted to be identical to the terminal's cache store sending and receiving data from the SUTTAC-Server to the terminal. In this case, each cache and corresponding cache can be adapted to store predetermined secret data.

The terminal is typically adapted to compare the alternative connection to the existing connection by comparing at least one of the following parameters:
a) The connection bandwidth;
b) The connection cost;
c) The connection speed; or,
d) The connection reliability.

The terminal can be adapted to compress, and thereby provide a first security level, the data to be transferred by:
a) Comparing the data to be transferred to the data stored in the first cache; and,
b) Determining matching data in accordance with the results of the comparison;
c) Modifying the data to be transmitted by replacing the matching data with a cache reference, the SUTTAC-Server being adapted to be responsive to the transmitted data to replace the cache references with the matching data from the corresponding first cache.

The terminal may be adapted to decompress data received from the SUTTAC-Server by:
a) Locating cache references in the received data, the cache references being generated by the SUTTAC-Server in accordance with data contained in the corresponding second cache;
b) Accessing the data stored in the second cache;
c) Modifying the received data by replacing the cache references with matching data with a cache store reference, the terminal including a corresponding cache store and being adapted to be responsive to the transmitted data to replace the cache store references with the matching data from the corresponding cache store.

The security system of the terminal can be adapted to encrypt/decrypt data the data to be transferred by:
a) Generating an encryption/decryption factor in accordance with the selected data stored in the cache store; and,
b) Encrypting/decrypting the compressed data in accordance with the generated encryption/decryption factor.

In this case, the encryption/decryption factor can be based on a checksum of the data contained in the first/second cache. The encryption/decryption factor can be used to generate an encryption/decryption key, the key being used in a encryption/decryption algorithm. The terminal may contain a cache store system being adapted to select the transmitted data to be stored.

The cache store system can be adapted to select the data in accordance with at least one of a number of criteria including:
a) Transmission frequency of the data;
b) The communications link used to transmit the data;
c) The data volume;
d) Any service requirements for the data transmission; or,
e) Any priority requirements for the data transmission.

Again, the terminal's connections may be split as described above into the groups LAN and RAS and into its four sub groups. At least one of the communications links described above can be established as a tunnel connection with from terminal to the SUTTAC-Server.

In a third broad form the present invention provides a system for allowing a user to connect to services using a remote terminal coupled to a SUTTAC-Server via one of a number of communications links, the SUTTAC-Server being coupled to the one or more services in use, the system including a SUTTAC-Server according to the first broad form of the invention and a terminal according to the second broad form of the invention.

In a fourth broad form the present invention provides a method of allowing a user to connect to services using a terminal coupled to a SUTTAC-Server via one of a number of communications links, the SUTTAC-Server being coupled to the one or more services in use, the method including causing the SUTTAC-Server to:
a) Authenticate the terminal by:
   (i) Obtaining an identifier from the terminal; and,
   (ii) Comparing the identifier of the terminal to device data, the device data being stored in a store, the device data including an indication of an identifier for each of a number of predetermined terminals authorised to access the remote services; and,
   (iii) Establishing a connection between the SUTTAC-Server and the terminal via at least one of the communication links, in response to the successful comparison;
b) Store data in a respective cache store, the cache store including:
   (i) A first cache adapted to store data transmitted to the terminal; and,
   (ii) A second cache adapted to store data received from the terminal; and,
c) Operate to switch the connection by:
   (i) Receive an alternative connection request from the terminal, the alternative connection request indicating that an alternative connection is to be established; and,
   (ii) Cooperate with the terminal to establish the alternative connection in response to the request;
d) Secure the data by performing at least one of
   (i) Encoding data to be transmitted to the terminal in accordance with the data stored in the cache store; and,
   (ii) Decoding data received from the terminal in accordance with the data stored in the cache store.

The method typically includes causing the SUTTAC-Server to operate as a SUTTAC-Server according to the first broad form of the invention.

In a fifth broad form the present invention provides a method of allowing a user to connect to services using a terminal coupled to a SUTTAC-Server via one of a number of communications links, the SUTTAC-Server being coupled to the one or more services in use, the method including causing the terminal to:
a) Participate in authentication by:
   (i) Generating an identifier in accordance with device data, the device data including an indication of an identifier for the terminal;
   (ii) Transfer the identifier to the SUTTAC-Server, the SUTTAC-Server responding to the identifier to determine if the terminal is authorised to access the remote services and, establish a connection between the SUTTAC-Server and the terminal via at least one of the communication links, in response to the successful determination;
b) Store data in a respective cache store, the cache store including:
   (i) A first cache adapted to store data transmitted to the terminal; and,
   (ii) A second cache adapted to store data received from the terminal; and,
c) Operate to switch the connection by:
   (i) Determining if an alternative connection can be established via one or more alternative communications links;
   (ii) Comparing the alternative connection to the existing connection; and,
   (iii) Transferring an alternative connection request to the SUTTAC-Server;
   (iv) Cooperating with the SUTTAC-Server to establish the alternative connection; and,
d) Secure the data by performing at least one of:
   (i) Encoding data to be transmitted to the SUTTAC-Server in accordance with the data stored in the cache store; and,
   (ii) Decoding data received from the SUTTAC-Server in accordance with the data stored in the cache store.

The method typically includes causing the terminal to operate as a terminal according to the second broad form of the invention.

### BRIEF DESCRIPTION OF THE DRAWINGS

Examples of the present invention will now be described with reference to the accompanying drawings, in which:

FIG. 1 is a schematic diagram of an example of a system according to prior art;

FIG. 2 is a schematic diagram of an example of a system for implementing the present invention;

FIG. 3 is a schematic diagram of the connectivity of the system of FIG. 2;

FIG. 4 is a schematic diagram of an example of one of the processing system of FIG. 2;

FIG. 5 is a schematic diagram of an example of one of the terminals of FIG. 2;

FIG. 6 is a flow chart of the process of registering a terminal with the SUTTAC-Server of FIG. 2;

FIGS. 7A and 7B are a flow chart of the process of forming a connection between terminal and the SUTTAC-Server of FIG. 2;

FIGS. 8A and 88 are a flow chart of the process of transferring data between the connection;

FIGS. 9A and 9B are a flow chart of the process of switching a connection between the terminal and the SUTTAC-Server of FIG. 2;

FIG. 10 is a schematic of an example of the logical structure of a terminal according to the prior art;

FIG. 11 is a schematic of an example of a terminal 3 according to the invention;

FIG. 12 is a schematic of an example of the main functional components of the terminal 3;

FIG. 13 is a schematic of an example of the logical structure of a SUTTAC-Server according to the prior art;

FIG. 14 is a schematic of an example of a SUTTAC-Server 1 according to the invention;

FIG. 15 is a schematic of an example of the main functional components of the SUTTAC-Server 1;

FIG. 16 is a schematic diagram of an example of a terminal 3 implemented for Windows XP notebook computers as the terminal;

FIG. 17 is a schematic diagram of an example of a SUTTAC-Server 1 implemented for FreeBSD Unix computers as the SUTTAC-Server;

FIG. 18 is a schematic diagram of a packaged product; and,

FIG. 19 is a schematic example of a product configuration process.

FIG. 20 is a schematic example of the implemented client structure

FIG. 21 is showing the TCP client stack embedding

FIG. 22 is showing the different Transport layers in MS-Windows environment

FIG. 23 is showing the basic application (Client and SUTTAC-Server) dataflow

FIG. 24 is showing the SUTTAC-Server structure

FIG. 25 is showing more detailed application (Client and SUTTAC-Server) dataflow

### DETAILED DESCRIPTION OF THE PREFERRED EMBODIMENTS

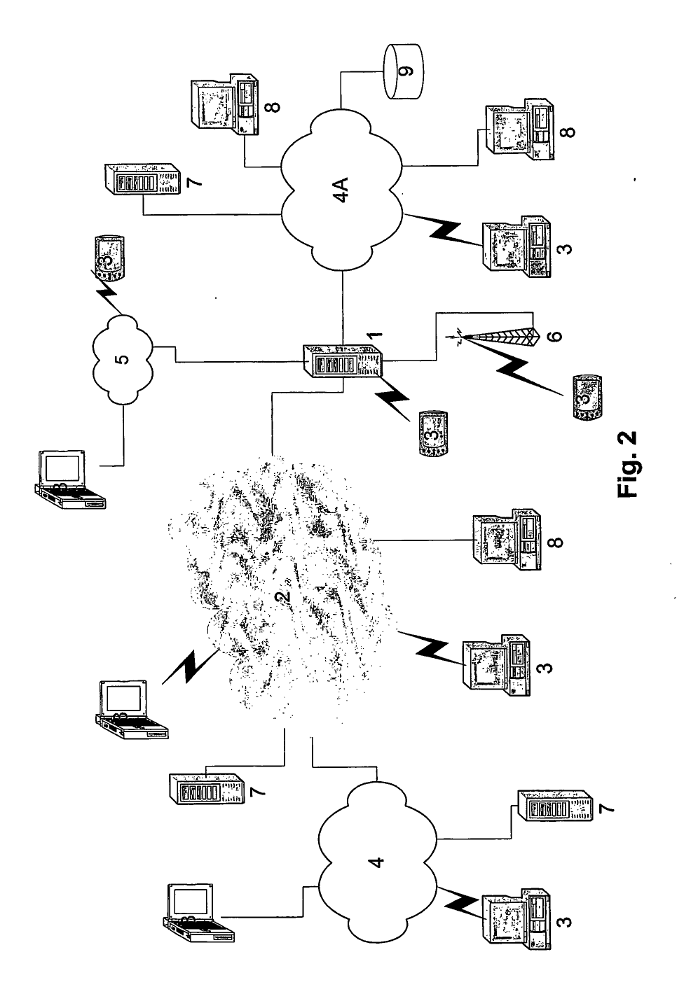

One example of the present invention will now be described with reference to FIG. 2 which shows a system adapted for implementing the present invention.

In particular, the apparatus includes a SUTTAC-Server 1 coupled to a number of terminals 3 via one or more communication systems such as the Internet 2, one or more local area networks (LANs) 4, a telephone communications network 5, such as the GSM mobile network, or POTS, or the like, a short white range wireless links via the antenna 6, or via internal antennas (not shown), as shown.

In use, the SUTTAC-Server 1 is adapted to act as a SUTTAC-Server to allow the terminals 3 to interconnect to a number of alternative data services. The services may take anyone of a number of forms and therefore may include interconnection to alternative processing systems such as servers 7, or alternative remote terminals 8, which may be coupled to any of the communications networks, including the Internet 2, the LANs 4, the telephone network 5, or the like, as well as to remote databases shown generally at 9, or the like.

In addition to this, the SUTTAC-Server also provides handover connectivity for the remote terminals 3 to each of the communications networks including the Internet 2, the LANs 4 and the telephone network 5, in a controlled and secure manner.

In order to achieve this, the SUTTAC-Server 1 is adapted to form secure connections with each of the terminals 3 and then route data received from the services to the terminal 3 as required and route data received from the terminals 3 to the services as required. Thus, one may recognize that said SUTTAC-Server acts as special device(s) with a secure and controlled, however, flexible connection from SUTTAC-Server to terminal to provide seamless connectivity to the one or more services in use. The inventive idea realizes a user and service friendly system with security/encryption features, user data persistence, traffic redirection if required, tunnelling and therefore improved security using public infrastructures, such as the Internet, and authentication and special caching (further details described below).

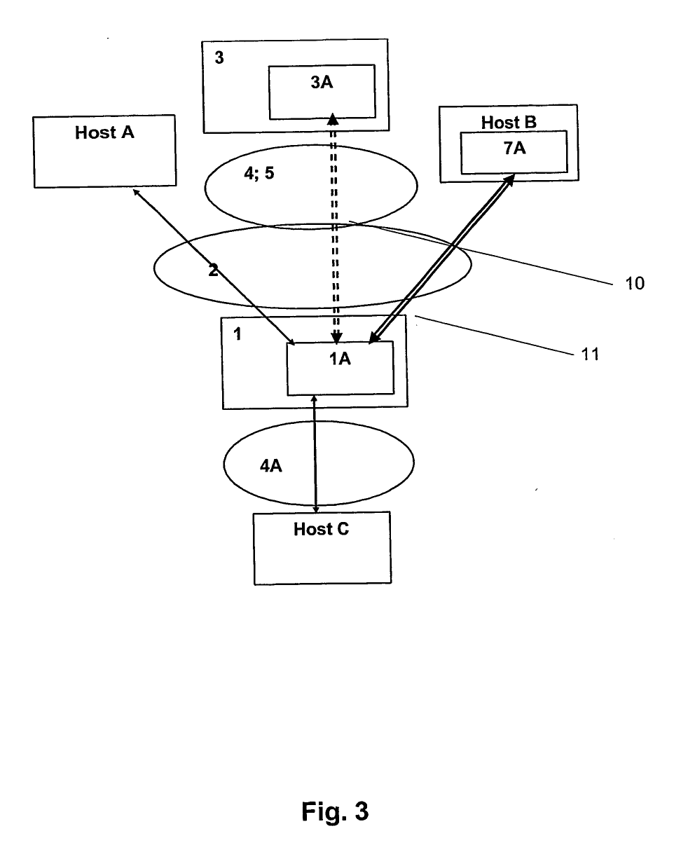

An example of the functional interconnectivity of the terminals 3 and the SUTTAC-Server 1 is shown in FIG. 3.

In this example, it can be seen that the SUTTAC-Server 1 include a SUTTAC-Server module 1A, with the terminal 3 implementing a client module 3A, both of which represent hardware/software applications required to implement the present invention.

Furthermore, each terminal 3 is connected to the SUTTAC-Server 1 only, via a secure connection shown at 10. In the SUTTAC-Server 1 is connected to services, such as the hosts A, B, C, which will be in the form of the servers 7, the terminals 8, the database 9, other terminals 3, or the like. In this example, when the SUTTAC-Server 1 is coupled to a server 7, such as the host B, this link may be implemented using a tunnel connection 11, as shown, with the tunnel being implemented using a tunnel module 7A.

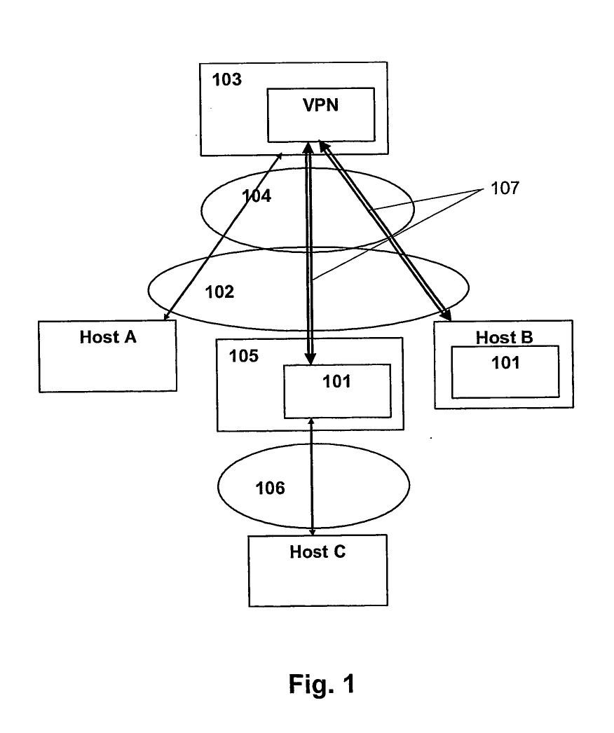

In any event, it will therefore be appreciated from a comparison of FIG. 3 and FIG. 1, that one of the major differences between the prior art is the fact that in the invention, all connections that pass redirect rules are routed through the SUTTAC-Server 1. This allows full control with regard to security, authentication, protocols and, as a further important feature, to reduce data traffic by implementing the compression/data reduction and/or caching features according to this invention, which is particularly important if the connection 11 is using wireless or other low bandwidth or high priced connections. The controlled connection between the SUTTAC-Server 1 and the terminal 3 provides the inventive seamless connection possibility and, hence, allows seamless switching dependent on the relevant parameters according to the user's needs.

The SUTTAC-Server 1 may then provide onward connectivity to any one of the number of different services, such as access to the communications networks 2, 4, 5, the servers 7, the terminals 8, or alternative ones of the terminals 3, as shown by the connections 11, 12 and 13.

FIG. 3 will be referred to in more detail below.

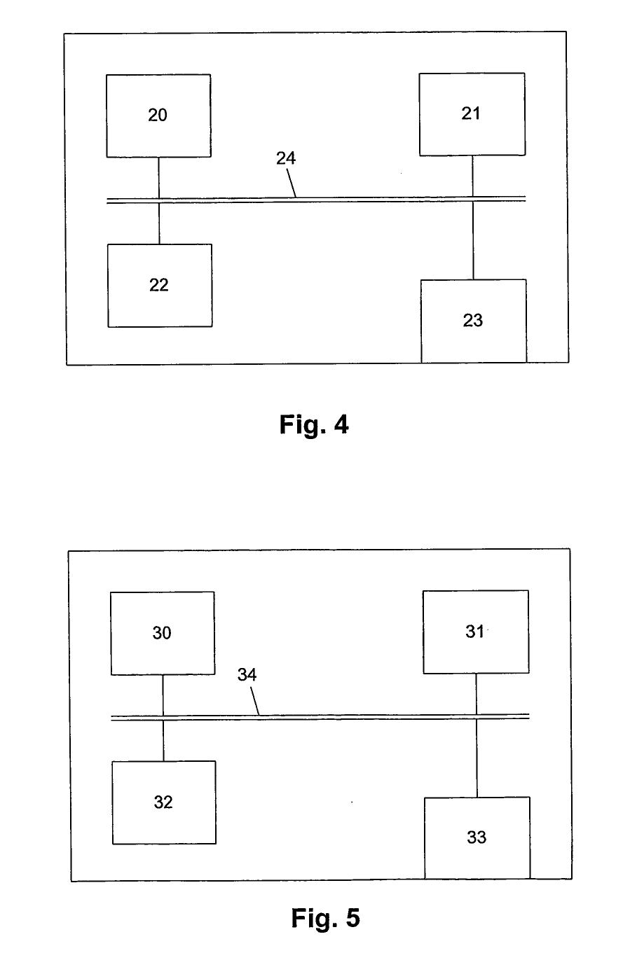

In order to achieve this the SUTTAC-Server is therefore adapted to interface with the terminals 3 and route data to and from the terminals 3 as required. In order to achieve this, the $UTTAC-Server 1 is typically formed from a processing system, an example of which is shown in FIG. 4. In this example the processing system includes a processor 20 a memory 21, an optional I/O (input/output) device 22 and an external interface 23 coupled together via a bus 24.

Accordingly, it will be appreciated that the SUTTAC-Server 1 may be any form of processing system, but is typically a server such as a web server, network server, or the like, adapted to perform the required functionality. However, alternatively the SUTTAC-Server 1 may be formed from specialised hardware and/or specialised software implemented on a suitable processing system. Thus, the term SUTTAC-Server does not need to be interpreted in a narrow sense and may be implemented in wireless communications, such as mobile telephony, special hardware elements such as ASICs or other computer/telecommunication peripherals or computer soft- or hardware modules. Accordingly, the functionality of the term SUTTAC-Server should include but not be limited to common hardware as that described herein according to the possible embodiments.

Similarly, in use the terminals 3 must be adapted to communicate with the SUTTAC-Server 1. This may typically be achieved by transferring data in accordance with TCP/IP protocols, or the like. The terminals 3 are also typically adapted to provide access to remote services such as e-mail, web browsing; or the like.

An example of a suitable terminal is shown in FIG. 5. In this example the terminal includes a processor 30 a memory 31, an I/O (input/output) device 32 and an external interface 33 coupled together via a bus 34. In use, the external interface provides connectivity to the SUTTAC-Server 1 as required. Again, the terminal may be realized as integrated circuit or application specific hardware. In a special embodiment one may think of a microchip on consumer cards, such as payment or telecommunication cards or the like. Furthermore, the method and system allows to realize terminals that allow offline data communication on portable devices; such as media players featuring DRM and the like. In each application different advantages of the present invention may be of importance/priority, such as data transfer security (with high flexibility regarding communication infrastructure), compression, caching or seamless switching.

Accordingly, it will be appreciated that the SUTTAC-Server 1 may be any form of processing system, such as a personal computer, lap-top, palm top, pen based computer, PDA, smart phone, or the like.

However, alternatively the terminal 3 may be formed from specialised hardware and/or specialised software implemented on a suitable processing system.

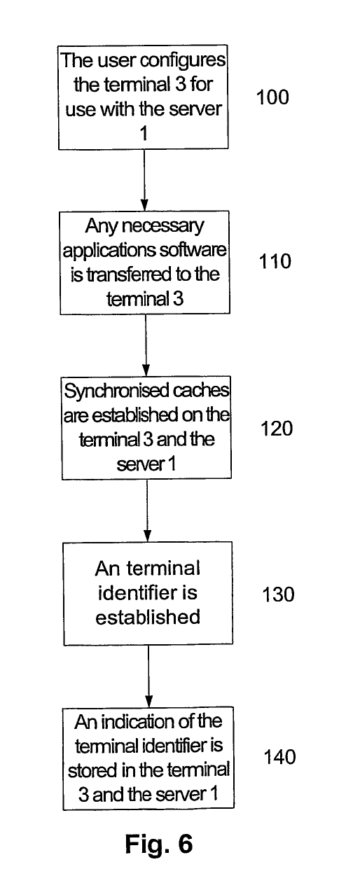

An example of operation of the system will now be described with reference to the flow charts set out in FIG. 6.

In particular, in order for a user to be able to use a selected one of the terminals 3 with the SUTTAC-Server 1 it is necessary for the terminal 3 and SUTTAC-Server 1 to be appropriately configured.

The user therefore configures the terminal 3 for use with the SUTTAC-Server 1 at step 100, and this will typically require the user to execute applications software stbred on the SUTTAC-Server 1, thereby causing the terminal 3 to be configured as required. It will be appreciated that the SUTTAC-Server 1 will also require configuration, and in particular installation of appropriate applications software, such as the SUTTAC-Server module 1A. This will typically be performed in a normal manner as will be appreciated by those skilled in the art, and for the purposes of this explanation it will be assumed that this has already been completed.

In order to maintain security of the SUTTAC-Server 1 it will be necessary for the user to be a registered user of the system. Accordingly, if the user is not previously registered with the system, the user will be assigned with authentication information, which allows the SUTTAC-Server 1 to authenticate the user's identity. After installation, before turning on the application for the first time, there is an activation code to be entered. This code is user unique and will be calculated from the SUTTAC-Server while configuring the user there. The authentication may typically be a username and password, although it will be appreciated that this may alternatively be in the form of a one time password, a public/private key pair, or the like. The authentication information may be stored in either the SUTTAC-Server 1, the terminal 3, or both, as will be explained in more detail below.

At step 110 any necessary application software, such as software applications for implementing the client module 3A is transferred to the terminal 3.

At step 120 synchronised caches are established from the terminal 3 and the SUTTAC-Server 1. The synchronised caches are adapted to store information that is transferred between the terminal 1 and the SUTTAC-Server 3 to provide for compression of data and additional security as will be described in more detail below.

It will be appreciated that a number of cache configurations can be used. However, in the present example the terminal 1 implements in a preferred manner at least an outgoing cache for storing data transferred to the SUTTAC-Server and an incoming cache for storing data received from the SUTTAC-Server 1. Similarly, the SUTTAC-Server 1 will also maintain equivalent incoming and outgoing caches storing data received from and transferred to the respective terminal 3. As a result the incoming cache on the terminal 3, and the outgoing cache on the SUTTAC-Server 1 will be identical, and similarly for the outgoing cache on the terminal 3, and the incoming cache on the SUTTAC-Server 1

The caches can optionally be pre-loaded with predetermined secret data at this point to aid in communications security, as will be described in more detail below.

At step 130 a terminal identifier is established. The terminal identifier is used by the SUTTAC-Server 1 to uniquely identify the terminal 3 in subsequent transactions. Accordingly, the terminal identifier may take anyone of a number of different forms. Thus for example, the terminal identifier may be in the form of a private key of a public private key pad which may be used to create a digital signature.

In use, the digital signature can be transferred from the terminal 3 to the SUTTAC-Server 1 and then decrypted using the corresponding public key. In this case, if the SUTTAC-Server 1 is able to retrieve predetermined information from the digital signature then this confirms the identity of the respective terminal 3.

Accordingly, an indication of the terminal identifier is stored at the terminal 3 and the SUTTAC-Server 1 at step 140. Once this has been completed the terminal 3 is ready for use with the system.

Operation of the system to allow a user to access services via the SUTTAC-Server 1 will now be described.

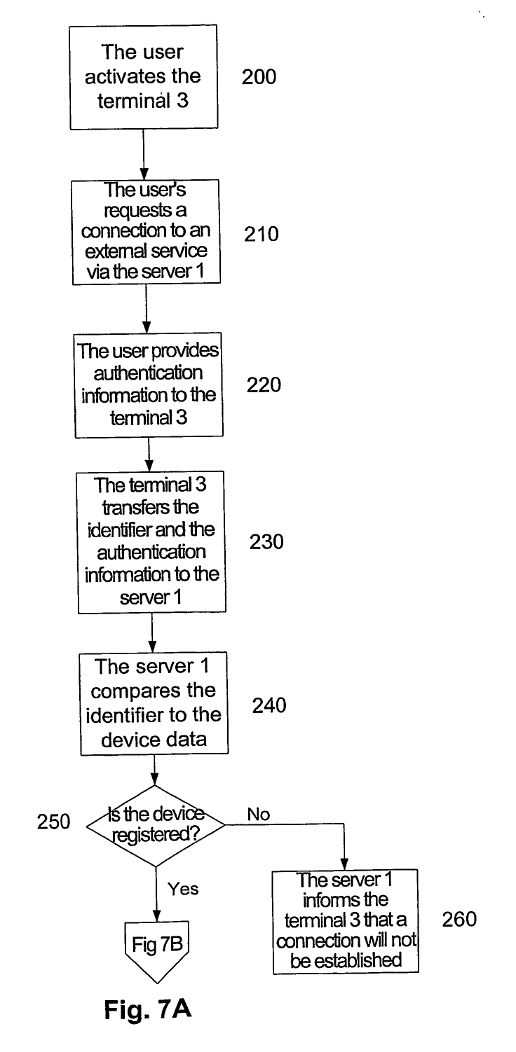

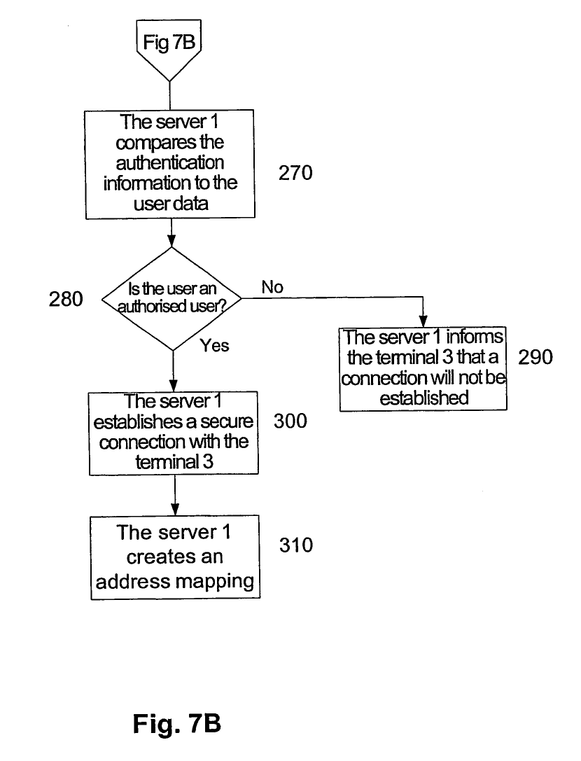

In particular, as shown in FIG. 7A at step 200 the user activates the terminal 3. At steps 210 and 220, the user requests a connection to an external service via the SUTTAC-Server 1 and provides authentication information. It will be appreciated that these steps may be performed simultaneously, or in any order, depending on the particular implementation of the system.

When the user submits their authentication information, such as the user name and password, one time password, digital signature, or the like, authentication will then be performed either by the SUTTAC-Server 1 or the terminal 3.

In the case of the SUTTAC-Server 1 performing the authentication, the terminal 3 transfers the authentication information and the identifier to the SUTTAC-Server 1 at step 230. In order to generate the identifier, the terminal may have to perform a number of different operations.

Thus, for example, the identifier may simply be stored in the terminal memory 31 in which case this can simply be downloaded and transferred with the received authentication information.

Alternatively, the identifier may be in the form of a digital signal which needs to be generated. The digital signature is typically generated in accordance with information stored in one of the caches. Thus for example, the terminal 3 may encrypt a checksum of a respective cache with a predetermined private key to create a digital signature.

The digital signature may then be transferred to the SUTTAC-Server 1 at step 230 for subsequent verification at step 240. Thus, at step 240 the SUTTAC-Server 1 compares the identifier to the device data to determine if the terminal 3 is registered with the system. This will typically involve having the SUTTAC-Server 1 decrypt the digital signature with a public key associated with the terminals private key. This would typically be stored in the store, and would be identified in accordance with the digital signature, or by alternative means such as a terminal ID.

The SUTTAC-Server 1 will then compare this to the checksum generated from the corresponding incoming cache and assuming these agree, this indicates that the terminal 3 is authorised to access the system. The SUTTAC-Server 1 will also compare the authentication information received from the terminal 3 to authentication information stored in the memory 21, or in an external database. Again, the exact manner in which this will be achieved will depend on the type of authentication information, as will be appreciated by a person skilled in the art.

At step 250 it is determined that the device is not registered, then the SUTTAC-Server 1 indicates to the terminal 3 that access to the services will not be provided at step 260.

Otherwise, at step 270 the SUTTAC-Server 1 proceeds to authenticate the user. It will be appreciated that this will not be required if user authentication is performed solely by the terminal 3. However, otherwise the SUTTAC-Server 1 will operate to compare the authentication information provided by the user to authentication information stored as user data stored in the memory 21, or in an external database. The user data will include the user name and password, or other authentication information, of each user authorised to use the system.

At step 280 the SUTTAC-Server 1 determines if the user is a registered user. The exact manner in which this is achieved will depend on the nature of the authentication information as will be appreciated by a person skilled in the art. If the user is not registered, the SUTTAC-Server 1 not informs the user at step 290 that access will not be provided. Otherwise at step 300 the SUTTAC-Server 1 establishes a secure tunnel connection with the terminal 3.

It will be appreciated that if the terminal 3 passes the credentials to the SUTTAC-Server 1, then this will typically be achieved by having the processor 20 compare the received authentication information with user data stored in the memory 21. This may be performed in addition to, or instead of the SUTTAC-Server 1 performing the procedure. If the SUTTAC-Server 1 does not perform authentication, then the information will not need to be transferred to the SUTTAC-Server 1 as described above.

At this point the SUTTAC-Server 1 will determine an address assigned to the terminal 3 to allow communication to be performed via the established communication link. It will be appreciated that the address of the terminal 3 will depend on the connection established and may typically therefore be in form of an IP address, or the like. In the case of an IP address, the exact address will depend on the manner in which the address is assigned.

Thus for example, if the terminal 3 is connected to the Internet 2 the terminal 3 will typically have an IP address assigned by a DHCP server, or the like. However, if this IP address is used in communication with the services, then this may cause problems in the communication. In particular, certain services may try to communicate directly with the terminal 3 and not via the SUTTAC-Server 1. Accordingly, the SUTTAC-Server assigns a predetermined terminal address to the terminal, the address including the sub-net mask of the SUTTAC-Server 1. A mapping of the predetermined address and the assigned terminal address is then stored at step 310. The manner in which this is used will be described in more detail below.

It will be appreciated that during the above process, sensitive data transmitted between the terminal 3 and the SUTTAC-Server 1, such as the authentication information, may be encrypted. This may be achieved in a number of ways, such as for example described below.

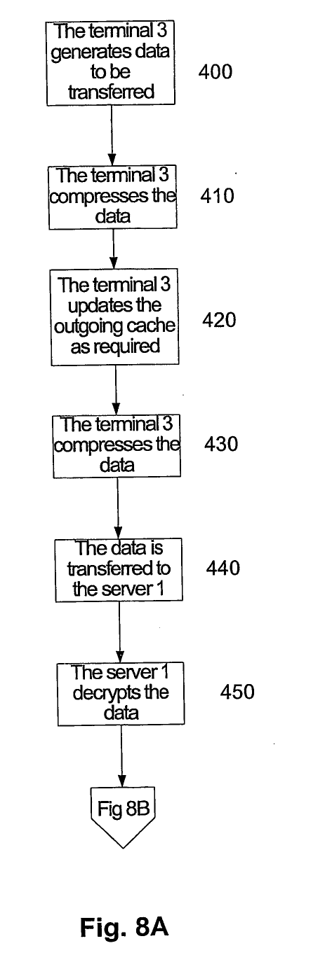

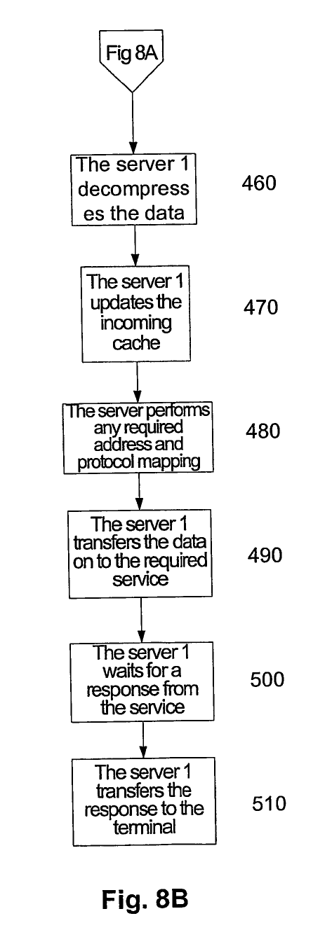

Once this has been completed, this allows data to be transferred between the terminal 3 and any one of the services as required, as will now be described with reference to FIG. 8A and SB.

In order to achieve this, the terminal 3 will first generate data to be transferred to the SUTTAC-Server 1 at step 400. It will be appreciated that this data may be in any one of a number of forms and may include for example e-mail, web browser commands, file transfer requests, FTP commands, or the like.

At step 410 the terminal 3 compresses the data using the contents of the outgoing cache. In particular, the outgoing cache is maintained to allow frequently used data to be substituted for cache references. In order to achieve this, the terminal 3 and the SUTTAC-Server 1 maintain identical caches as mentioned above.

In this case the terminal 3 will search the outgoing cache for any data that is identical to the data being transferred to the SUTTAC-Server 1. Thus, it will be appreciated that an e-mail may be sent with an identical e-mail attachment a number of times. In this case, the e-mail attachment can be stored in the cache and simply replaced by cache reference when the data is to be transferred to the SUTTAC-Server 1.

Generally however it is not whole attachments or the like which are substituted but rather data fragments, the size of which will depend on system configuration and which may be adjusted in accordance with administrator settings.

As, the cache reference is generally smaller in size than the corresponding data and accordingly, this results in the data being compressed. In addition to this, this compression technique provides additional security as the original data can only be retrieved by individuals holding a corresponding identical cache. As the cache is based on all previous communication between the terminal 3 and the SUTTAC-Server 1, this could only be achieved by third parties eavesdropping on all previous communication between the terminal 3 and the SUTTAC-Server 1, and using the same algorithm to maintain the cache contents, as will be described in more detail below. In any event, it will be appreciated that this is extremely unlikely.

In addition to this, if the cache includes predetermined secret information it makes it virtually impossible for the third party to have an identical cache, thereby further improving the security compaired to soly encryption.

At step 420 the terminal 3 updates the outgoing cache as required. In order to do this, the terminal 3 will execute an algorithm which reviews the data being transferred to the SUTTAC-Server 1 and analyse various criteria regarding the data transfer. The criteria will include factors such as:
The frequency with which respective data is transferred;
The bandwidth required for the transfer;
The cost of the transfer;
The time at which the information is transferred;
Other suitable criteria.

The algorithm will be biased such that frequently transferred information is included in the cache and may therefore be replaced with a cache reference. Additionally, the algorithm will be adapted to take into account the user's habits as will be described in more detail below.

It will be appreciated that the cache may alternatively or additionally be updated manually.

At step 430 the terminal 3 encrypts the data as required. Again, the encryption may be performed in any number of ways including for example Huffman coding, or the like. Preferably however the terminal 3 encrypts the data in accordance with the cache contents. Thus for example, a checksum of the cache may be used to generate an encryption key which may be used to encrypt the data in accordance with a predetermined algorithm.

Again, the security from a purly encription system will be improved if predetermined secret information is pre-loaded into the caches.

At step 440 the data is transferred to the SUTTAC-Server 1 which operates to decrypt data at step 450. The decryption is again carried out in accordance with the same predetermined algorithm. In this case, as the encryption is generated using a checksum based on the outgoing cache of the terminal 3, the SUTTAC-Server 1 can generate a decryption key based on the checksum of the incoming cache. As the checksum of the two caches will be identical, this allows the information to be successfully decrypted.

At step 460 the SUTTAC-Server 1 decompresses the data in accordance with the content of the incoming cache. Accordingly, the SUTTAC-Server 1 operates to access any cache references included in the data and then replace these with data from the corresponding location in the cache.

Once this has been completed the SUTTAC-Server 1 then updates the incoming cache in accordance with the same predetermined algorithm used by the terminal 3 to update its outgoing cache. As a result, this maintains cache integrity ensuring that both the outgoing cache of the terminal 3 and the incoming cache of the SUTTAC-Server 1 remain identical. In this preferred embodiment one may recognize that data caching, compression and encryption is resulting in a dynamic and, hence, very secure manner. The data caching, namely in low bandwidth connections, will result in a reduction of data to be transmitted and, thus, may reduce costs for users and infrastructure, while at the same time enhancing security.

At step 480 the SUTTAC-Server 1 performs any required address and protocol mapping. Thus for example, while having a tunnel connection, a predetermined IP address has been assigned to the terminal 3 and operate to replace the current terminal address shown in the data with the predetermined address. As a result of this, when the service responds to the terminal 3 it will insert the predetermined terminal address in the data it is transferring, causing the data to be transferred to the SUTTAC-Server 1. This allows the SUTTAC-Server 1 to replace the terminal address in the data with the original terminal address, allowing the data to be transferred to terminal 3.

Similarly, the SUTTAC-Server 1 will determine the protocol with which the data has been transferred and operate to modify this if necessary. One example of the situation in which this is required is if the link with terminal 3 is established via a GPRS or other similar connection which has a high associated expense. In this case, it is typical for data to be excluded from the connection. The reason for this is the data can continue to be transmitted to the terminal 3 even after the terminal 3 has terminated the connection. This can lead to additional expense to the user of the terminal 3.

Accordingly, the SUTTAC-Server 1 performs a protocol mapping, such data is transferred between the service and the SUTTAC-Server 1 in accordance with the UDP protocol, and between the terminal 3 and the SUTTAC-Server 1 in accordance with the TCP protocol. In this case, even if the service continues to transfer data, this will occur between the SUTTAC-Server 1 and the service, thereby reducing the use of the link to the terminal 3, which in turn reduces costs.

The data can then be transferred to the required service at step 490, or be responded to as required by the SUTTAC-Server 1.

It will be appreciated that the data in the form of a response is received from the service by the SUTTAC-Server at step 500, before being transferred back to the terminal at step 510. The transfer of data from the SUTTAC-Server 1 to the terminal 3 occurs in a similar manner to that described above, and will not therefore be described in any detail. Furthermore, special embodiments may foresee filter systems to avoid transfer of undesired data from the SUTTAC-Server 1 to the terminal 3, e.g. to suppress spam mails, advertising data or the like. These filter systems may be configurable by the terminal 3.

Thus, the SUTTAC-Server 1 performs any required address and protocol mapping, before compressing and encrypting the data in a manner similar to that described above. In this case, the compression and decryption will be performed using the outgoing cache of the SUTTAC-Server 1, with the subsequent decryption and decompression by the terminal 3 being performed using the corresponding incoming cache.

The SUTTAC-Server 1 therefore provides interconnectivity between the terminal 3 and the SUTTAC-Server 1, allowing the terminal 3 to be used to view web-pages, transfer e-mail, and access other services provided.

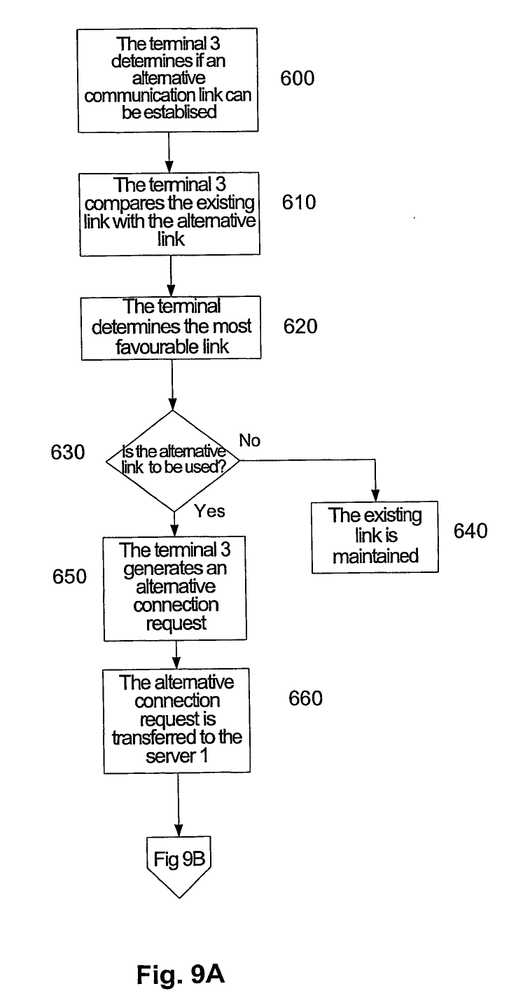

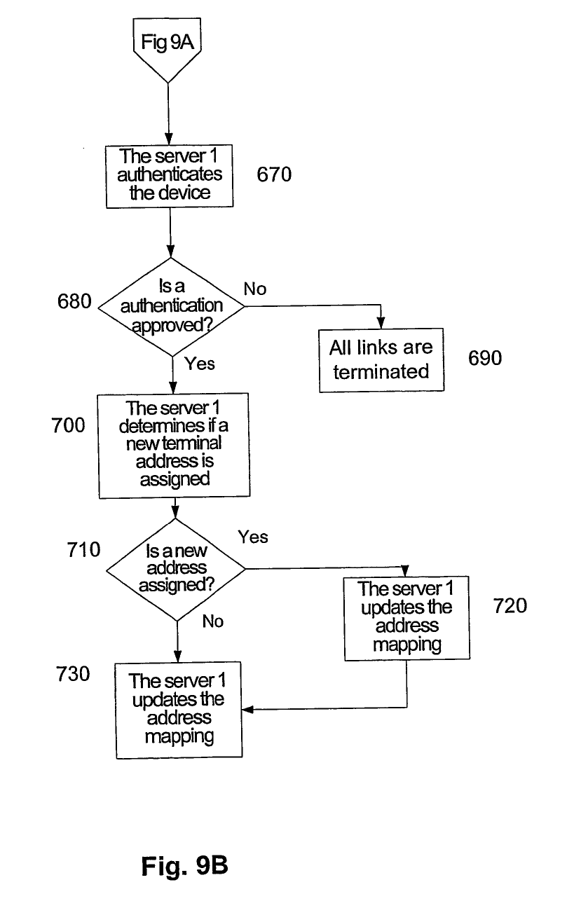

One example will now be described with reference to FIGS. 9A and 9B.

In particular, as shown at step 600 the terminal 1 operates to determine if an alternative link can be created. It will be appreciated that this can be achieved in accordance with a number of techniques, and may involve having the terminal 3 poll the SUTTAC-Server 1 via different communications links, or receiving polling signals from the SUTTAC-Server 3, or detecting the presence of a new available network for connection.

In any event, at step 610 the terminal 1 compares the existing link with the new alternative link. The comparison is performed in accordance with a number of predetermined criteria. This includes for example criteria such as:
The cost of transferring data via the link;
The available bandwidth;
The required quality of service of the connection;
The reliability of the connection;
Other criteria.

The terminal 1 uses the results of the comparison to assess which link would be preferable to use. If it is determined that the alternative link is not to be used at step 630, the existing link is maintained between the SUTTAC-Server 1 and terminal 3 at step 640.

Otherwise, at step 650 the terminal 3 will generate an alternative connection request which is transferred to the SUTTAC-Server 1 at step 660. The SUTTAC-Server 1 is responsive to the request to allow the alternative connection to be established.

Accordingly, at step 670, the SUTTAC-Server 1 will operate to authenticate the device in accordance with the identifier, as described above with respect to steps 230 to 260. Thus, the SUTTAC-Server 1 will require the terminal 3 to provide the identifier, which will then be compared to the device data, allowing the SUTTAC-Server 1 to confirm that the terminal 3 is registered to use the system.

Assuming that the identifier confirms the identity of the terminal itself, then no further authentication is performed for the user. This is performed so that the user does not have to enter their authentication information each time the communications link between the terminal 3 and the SUTTAC-Server 1 switches. Instead, the user will only be required to an input authentication information under a number of circumstances, as described in more detail below.

If the device is not authenticated at step 680 for any reason the all the communications links are terminated at step 690 for security purposes. However, it will be appreciated that alternatively, the existing link may be retained.

Otherwise, the SUTTAC-Server 1 determines if the terminal address assigned for the alternative connection is different to the address for the previous link at steps 700 and 710. If so, at step 720 the SUTTAC-Server 1 will operate to update the mapping stored in the store to reflect the mapping to the new terminal address.

Otherwise, or following this, the link is ready for use at step 730.

It will be appreciated that this is just one example of how the switching may be achieved. As an alternative, for example, the switching may be performed by having the SUTTAC-Server 1 detect polling signals from the terminal 3, or by having the SUTTAC-Server 3 examine alternative connections to determine if the terminal 3 can be contacted.

User Authentication

As described above, the system is configured so that user authentication is not required each time the communications link is switched. Instead, the user will only be required to an input authentication information under a number of circumstances these include for example:
Forming a new connection between the terminal 3 and the SUTTAC-Server 1;
If the terminal 3 has not been used for a predetermined amount of time;
If the terminal 3 is used in a new location; and,
Other criteria.

Requiring re-authentication in accordance works:
in two cases: connection switching on client and inactivity timeout. Both will happen if and only if re-authentication has been enabled on base-station. Currently re-authentication is client-side only, i.e. it is neither pushed from server nor stops data transfers. And there's no “location-based” re-authentication.
with the location of the terminal 3 provides additional security by allowing the SUTTAC-Server 1 to track usage of the terminal 3. In this case, when the user of the terminal 3 first uses the terminal in a new location, such as in a café, at home, in a new office, or the like, the user may be required to complete their authentication information so that the SUTTAC-Server 1 can confirm that the terminal 3 has not be stolen or utilised by a third party. Once this is completed, the SUTTAC-Server 1 will update location information stored in the memory 21 allowing the SUTTAC-Server to authenticate the terminal 3 in the respective location automatically in future.

In general, location information can be obtained in a number of ways depending on the form of the communications link. Thus for example, if the terminal 3 is coupled to the SUTTAC-Server 1 via the GPRS network, then this is usually capable of providing location information. Alternatively, if the network is a hard wired connection or the like this may be utilised to represent the location of the terminal 3.

In addition to this, the location information stored in the store could be synchronised with the user's address book on their computer such that if the computer is used at any of the locations from the user's address book authorisation will again be automatic. It will be appreciated that features such as this can be selected manually.

Caches

In the example described above. A respective cache is provided for incoming and outgoing traffic transferred between the SUTTAC-Server and a respective terminal. However, in addition to this, it is also possible to provide a respective cache for each type of data being transferred between the SUTTAC-Server 1 and a respective terminal 3. Thus, for example, the system may implement a cache for web-pages, a cache for e-mails, or the like.

A further feature that may be provided by the present invention is predictive cache updating, which allows the SUTTAC-Server 1 to learn the habits of users and download information in advance before requested by the user. Thus for example, if the user has a tendency to view selected web pages at a certain time of the day via a GPRS connection the SUTTAC-Server 1 will be adapted to automatically upload these pages to the terminal 3 in advance when the terminal 3 is connected via a higher bandwidth connection via a LAN or the like.

In this instance, when the user then attempts to browse the pages via the GPRS connection, the web page itself does not need to be transferred via the connection, and instead cache references can be transferred, allowing the terminal 3 to display the pages from the cache. This vastly reduces the amount of data that needs to be transferred via the narrow band high cost link. This will vastly decrease the amount of data that needs to be transferred, thereby improving the efficiency of the link.

### SPECIFIC EXAMPLES

Two specific examples of the invention will now be described.

The first example described above with respect to FIG. 4, will now be described in more detail. In particular, in this example, the connection 10 between the terminal 3 and the SUTTAC-Server 1 is implemented as a cached, compressed, persistent, secure, switched (CCPSS) tunnel.

In this case, as mentioned above, the terminal 3 typically includes at least one network interface, and fitted with the client module, embodied as a software, firmware or hardware implementation.

Similarly, the SUTTAC-Server 1, which operates as the SUTTAC-Server (and will hereafter be referred to as the SUTTAC-Server), is typically a computer provided with at least one network interface, and fitted with the SUTTAC-Server module 1A, embodied as a software, firmware or hardware implementation.

The CCPSS tunnel is the logical connection and protocol used to transfer data between the terminal and SUTTAC-Server. As illustrated in FIG. 3, the tunnel is generated and maintained by the client module 3A at the terminal end, and by the SUTTAC-Server module 1A at the SUTTAC-Server end.

FIG. 2 illustrates the way that data communications infrastructure is employed by the system to provide access to data services. For comparison with the existing art, the three data service access scenarios used in FIG. 1, are illustrated in FIG. 2. In this case using the system the three data access paths are:
Host A: The terminal 3 communicates with host computer A by means of an ordinary TCP/IP protocol connection or connectionless UDP/IP. The data communication packets are encapsulated and transported to the SUTTAC-Server through the CCPSS tunnel. The SUTTAC-Server module recovers the packets and routes them to host A.
Host B: The terminal 3 communicates with host computer B by means of a secure data communications protocol, such as IPSec or one of the many proprietary virtual private network (VPN) protocols available. Again the data communication packets are encapsulated and transported to the SUTTAC-Server through the CCPSS tunnel. The SUTTAC-Server module recovers the packets and routes them to host B, through a corresponding VPN tunnel or the like shown at 11.
Host C: A terminal communicates with host computer C located on a private intranet, such as the LAN 4A. The communications pathway is divided into a secured segment across the public networks and an unsecured segment across the intranet. The secured segment consists of a CCPSS tunnel. The SUTTAC-Server module recovers the packets and routes them to host C.

Features of the functionality implemented by the terminal 3 will now be described in more detail.

The Client Module

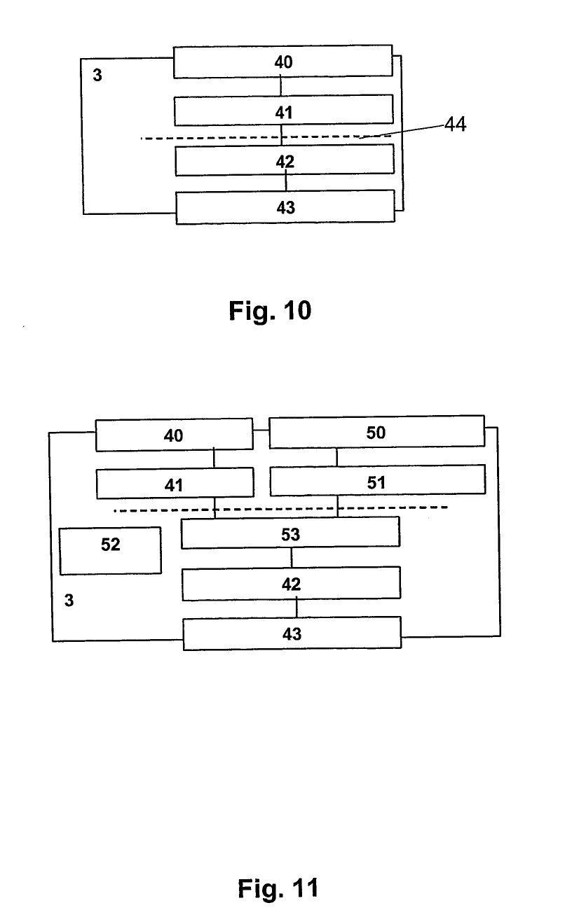

FIG. 10 illustrates the structure of the environment for software applications, running on a terminal 3 according to the prior art.

In this case, the components of this structure include:
A user interface 40, which typically present a visual or audio interface that enable users to interact with the application. This component may be absent in some basic service applications.
One or more user applications 41 which are the executing programs that provide the instructions that determine the behavior of the application.
One or more network protocol stacks 42, which implement the network addressing, packet formatting, security, and other protocol logic required to communicate successfully over a network. Examples of network stacks are the TCP/IP and UDP/IP stacks in common use today.
A network interface 43, which allows the terminal to connect to one or more networks.

In this case, the user applications 41 may be coupled to the network protocol stacks by a network API 44, as will be appreciated by persons skilled in the art.

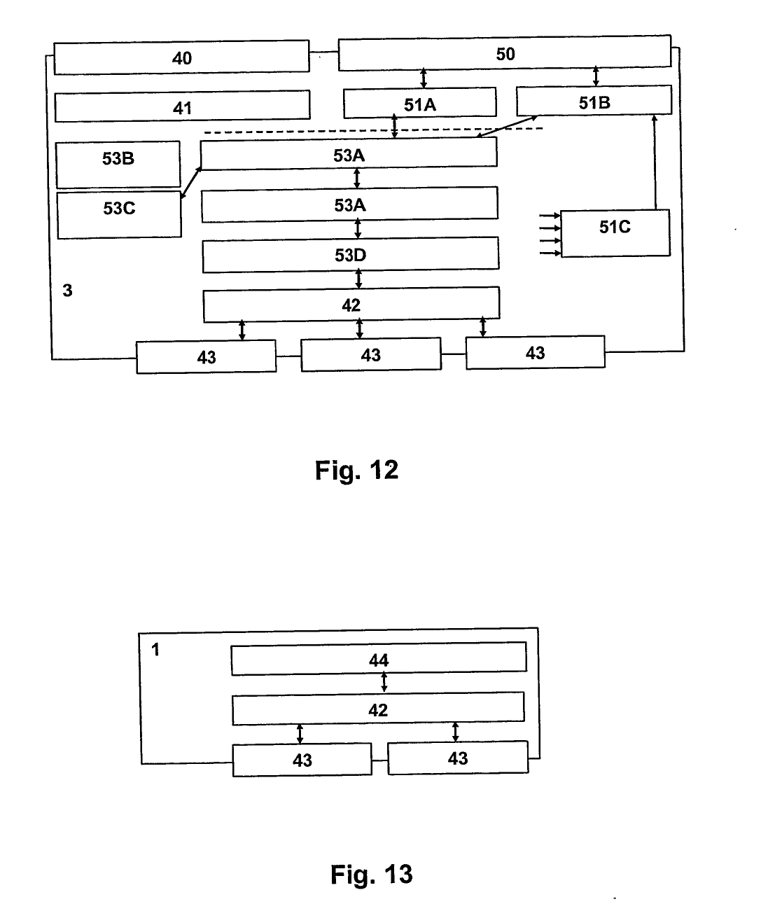

When the client module 3A is employed the terminal architecture is different from that shown in FIG. 10. The new top-level structure is shown in FIG. 11. This top-level architecture is refined in FIG. 12 to reveal the functional components that are preferred to implement the client module 3A.

The following sections describe the new top-level and functional components:
A terminal user interface (UI) 50 is provided to allow the user to view and control the functions of the system using this interface. This UI displays the status of network interfaces, as well as statistics of traffic per interface, per unit time and per application or protocol port number. When positive user authentication is required, this UI is used to recognize the user credentials.
Terminal applications 51 are the main applications that are specific to the terminal, and include:
   A control application 51A, which is used in user authentication, enabling the user to manually switch network interfaces and restrict access to nominated expensive transports by applications that are not considered high value enough to use such expensive bandwidth.
   A logging application 51B, which application is able to display network statistics via the UI and communicate any logging information that is not available otherwise to the SUTTAC-Server. The logging application 51B is associated with a log collection 51C which is a service/daemon component that collects raw statistics for use by the logging application.
A secure file system 52 that is provided to protect the privacy of information stored on the terminal 3. It is preferred that the terminal 3 be equipped with an encrypted file system.
A terminal protocol stack 53 which is used to generate the CCPSS tunnel at the terminal end. The functional components of the stack are:
   A compression/decompression component 53A, with the primary compression method being to use the synchronized caches provided at the terminal and SUTTAC-Server to replace repeated sequences of bytes by cache references. The compression converts a byte sequence to be transmitted into a sequence of literal and cache reference tokens. Decompression recovers the original sequence by looking up cache references from the decompression cache.
   One or more compression caches 53B which contains sequences of bytes that have been transmitted to the SUTTAC-Server. More than one compression cache may be used. As examples, caches may be allocated per protocol port/application, per mime-type or per connection. In any case, the SUTTAC-Server employs a corresponding set of decompression caches that have identical content to the corresponding terminal compression cache at identical positions in the transmitted stream of bytes.
   One or more decompression caches 53C which contains sequences of bytes that have been received from the SUTTAC-Server. More than one decompression cache may be used. As examples, caches may be allocated per protocol port/application, per mime-type or per connection. In any case, the SUTTAC-Server employs a corresponding set of compression caches that have identical content to the corresponding terminal decompression cache at identical positions in the transmitted stream of bytes.
   In general it is useful to store backup copies of these caches to enable efficient compression at terminal startup time. For efficient use of the caches for compression, duplicate sequences should not be stored, and sequences that occur frequently should be stored so that they can be referenced using short cache addresses. A person skilled in the art can readily implement such caches.
A user level security component 53D which optionally encrypts/decrypts and digitally signs/verifies signature for transmitted data. Many algorithms are known in the art for these operations. The novel step that is employed by this component is to hash a checksum of the synchronized cache as part of a shared secret between the terminal and SUTTAC-Server.
A network interface switching component 53E which monitors the status of available network interfaces to determine which interfaces are able to provide a communications path to the SUTTAC-Server. In the case that a less expensive or higher bandwidth connection is available, the newly available connection is used. Note that the most expensive connections should not be used to send probe packets to the SUTTAC-Server, in order to avoid unnecessary cost.

It may be foreseen that, after a de-synchronization of the checksum hash, that terminal and SUTTAC-Server initiate a new communication by applying a hash of a different cache area or reinitiate an encryption using the initial authentication mechanism.

The Server Module

FIG. 13 illustrates the logical structure of a firewall/Server as realised in the prior art. In this case, the majority of the components are similar to those described with reference to FIG. 10 for the terminal 3. In this case, similar reference numerals are used, and the components will not be described in any further detail.

In addition to this, there is just one component that did not already appear in relation to FIG. 10, as follows:
A packet router component 44 which receives data from network interfaces, typically after some processing by network protocol stacks 42. In the case of a tunnelling protocol, the data is typically unencapsulated and forwarded on without address translation. The outgoing data is written to a network interface, typically after some processing by network protocol stacks.

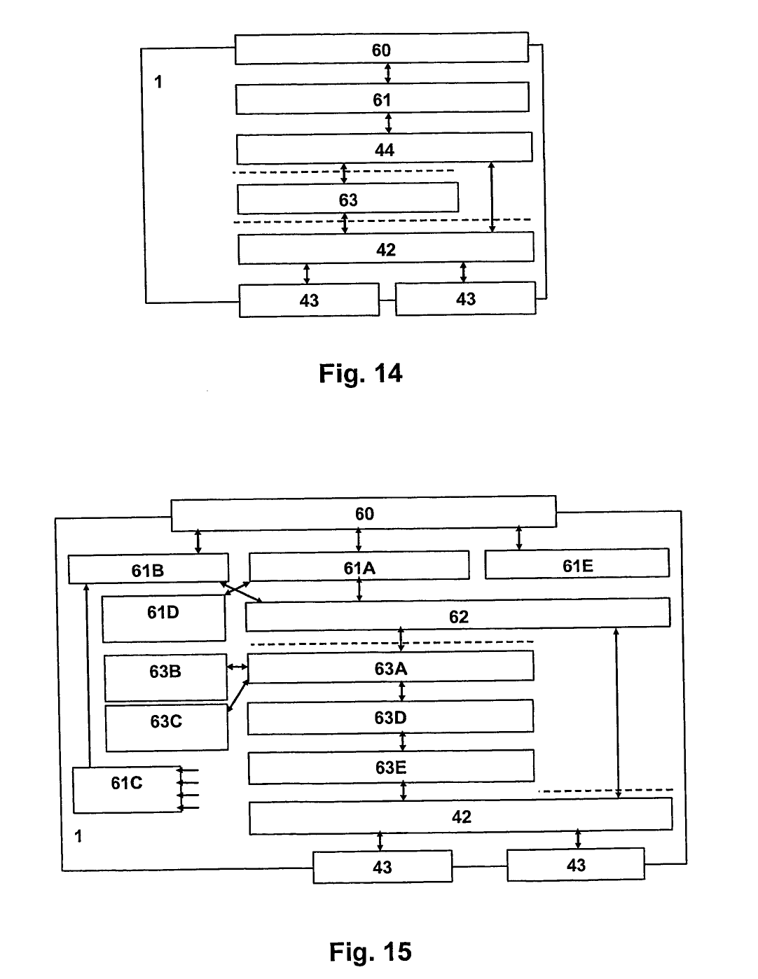

When the server 1 is operating as a SUTTAC-Server in accordance with the invention, the module is employed the SUTTAC-Server architecture is different from that shown in FIG. 13. The new top-level structure is shown in FIG. 14, with this top-level architecture being refined in FIG. 15 to reveal the functional components that are preferred to implement the SUTTAC-Server module.

The following sections describe the new top-level and functional components:
A SUTTAC-Server User Interface (UI) 60, which allows a user can view and control the functions of the system using this interface. This UI displays the status of network interfaces, as well as statistics of traffic per interface, per unit time and per application or protocol port number. This UI also allows the authorisation/de-authorisation of terminals and terminal users. In order to provide for remote management of the SUTTAC-Server, this UI is preferably implemented as a remotely accessible interface, such as a secure HTML web interface for example.
SUTTAC-Server Applications 61 are provided and these are the main applications that are specific to the SUTTAC-Server. These include:
   A control application 61A, the main functions of which application includes user authentication, and access control.
   A logging application 61B which is able to display network statistics via the UI and receive any statistical information that terminals send to the SUTTAC-Server. The logging application is associated with a log collection 61C which is a service/daemon component that collects raw statistics for use by the logging application.
   An authorization database 61D: The information required to authenticate and authorize terminals and users is maintained in this database.
   A report generator 61E which generates on-demand or periodic reports of user activity and communications volumes, estimated costs and any other information that may be useful for auditing, non-repudiation, capacity planning, applications re-engineering and other purposes.
A modified packet router 62 which employs existing practices for packet routing, except that connections to target hosts are maintained active while a terminal is unreachable due to lack of network connectivity.
A protocol stack 63 which is the central component that generates the CCMPSS tunnel at the SUTTAC-Server end. The functional components of the stack are:
   A compression/decompression component 63A similar to the equivalent compression/decompression component 53A described above with respect to the terminal 3.
   Compression/decompression caches 63B/63C, similar to the compression and decompression caches 53B, 53C described above with respect to the terminal 3. In this case, a respective cache is provided for each terminal,
   A user level security component 63D similar to the user level security component 53D described above for the terminal.
   A network interface switching component 63E which monitors for switched traffic from terminals 3. Following the recognition and binding of a terminal to a new IP address, the SUTTAC-Server interface switch simply passes a persistent terminal identifier to the higher levels of the stack.
      The CCPSS Tunnel

As described above, the system transports data across the access network used by the terminal 3 by means of a CCPSS tunnel. The CCPSS tunnel is designed to overcome problems in access networks and in roaming within and across access networks.

The CCPSS tunnel provides the following functionality:
Caching: Data transferred between the terminal and SUTTAC-Server is cached at both ends. This shared information about transferred data is useful for compression and security purposes. One or more transmit caches and one or more receive caches are maintained on both the terminal and the SUTTAC-Server. The terminal transmit cache content is the same as the corresponding SUTTAC-Server receive cache, when the identical position in the data communication stream is processed. The SUTTAC-Server transmit cache is similarly synchronised with the corresponding terminal receive cache.
Compression: Given the existence of synchronised caches, it is possible to reduce the amount of data traffic by replacing any segment of data that occurs in the transmit cache by a reference or pointer to that cache entry. Thus, compressed data can be represented as a sequence of literal and cache reference tokens. The larger the cache, the more compression can typically be achieved. A good caching algorithm keeps often referenced data without duplication.
Monitoring: The terminal and SUTTAC-Server keep statistical information about the amount of traffic transmitted and compressed. This information is useful to collect so that it can be presented indexed by time, user, and port or application.
Persistence: In the case that the data communication connection between the terminal and SUTTAC-Server is temporarily lost, the terminal maintains the appearance of a logical connection for the terminal application software. Similarly the SUTTAC-Server maintains the appearance of an intact logical connection towards the target host software.
Security: Data transferred between the terminal and SUTTAC-Server is encrypted and digitally signed to provide security. The synchronised caches can be used to increase security by including a checksum computed over the cache as part of a shared secret between the terminal and SUTTAC-Server.
Switching: In the case that the terminal switching component detects that multiple access networks are available for the transfer of data between the terminal and SUTTAC-Server, the switching component transfers data using the most economical and/or highest available bandwidth means.

The design of an efficient CCPSS protocol can be readily carried out by a person skilled in the art. Any monitoring data that needs to be exchanged between the terminal and SUTTAC-Server can be transported normally through the CCPSS tunnel as application traffic. Security may be implemented with minimal protocol overhead using secret key technologies; Alternatively public key mechanisms may be used. Switching simply requires a control packet that identifies a new terminal to IP address binding to enable the SUTTAC-Server to recognise the new terminal IP address.

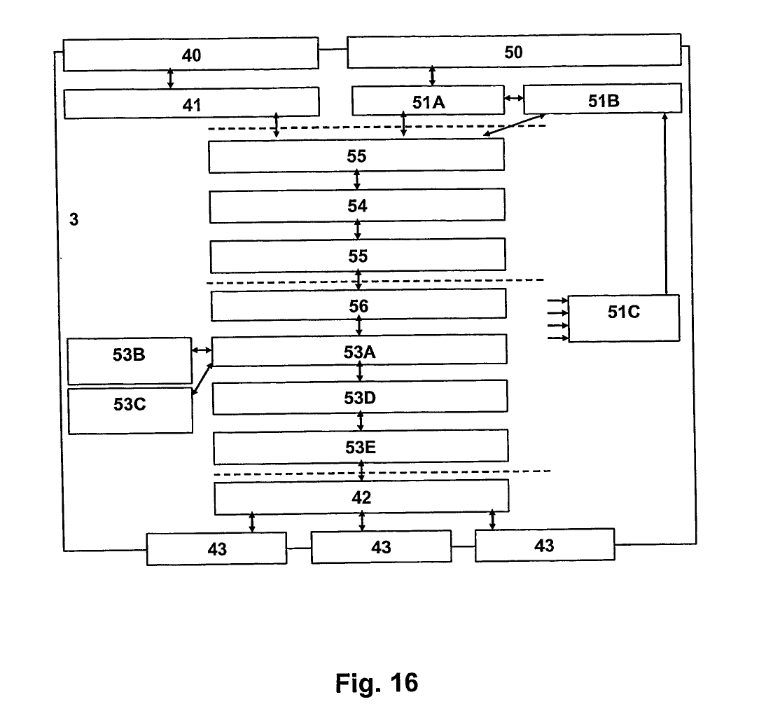

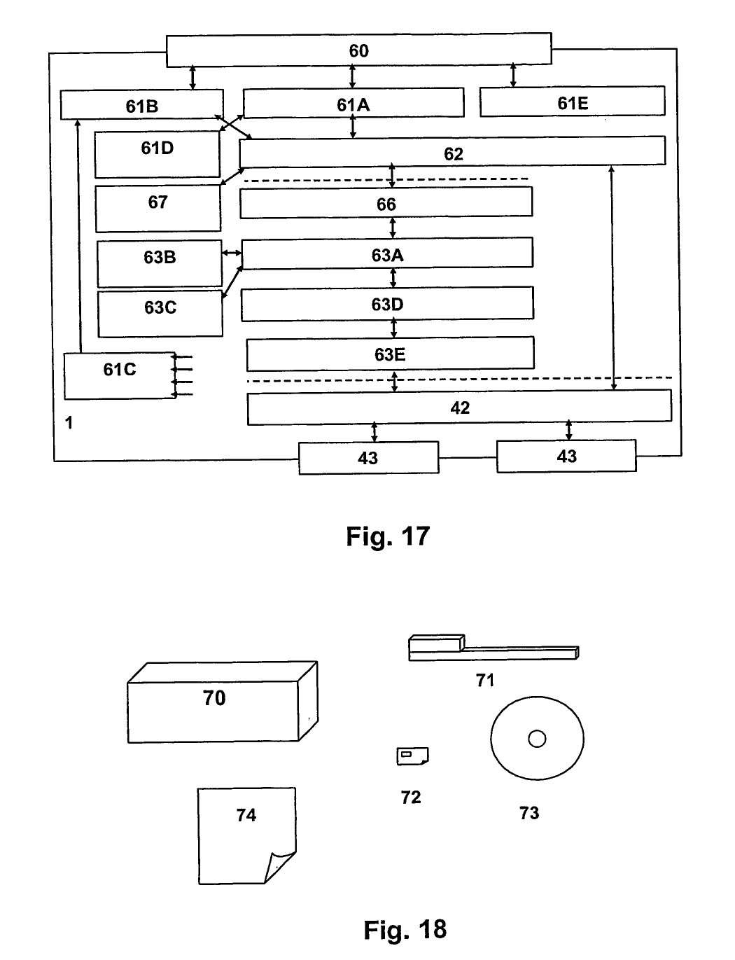

FIGS. 16 and 17 represent a specific implementation of a Windows XP notebook computer as the terminal 3, and a FreeBSD Unix Server as the SUTTAC-Server.

The initial terminal implementation design is similar to that shown in FIG. 12, with the SUTTAC-Server design being similar to that shown in FIG. 15.

However, the following implementation details are significant for the terminal 3:
Virtual Network Interface 54 and stacks 55: The terminal protocol stack 55 is implemented as a separate process. Applications access the stack through a Windows virtual network interface. The stack uses the normal Win32 network API to perform network transport operations. Note that this approach is not optimised for performance. Subsequent implementations will implement the terminal protocol stack as a lower level Windows NDIS driver.
Connection Multiplexing/De-multiplexing 56: This embodiment employs a single compression cache and a single decompression cache at the terminal 3, and the corresponding pair of compression and decompression caches at the SUTTAC-Server 1. In order to ensure synchronisation of cache access, multiple network connections are multiplexed into a single TCP/IP connection between the terminal and SUTTAC-Server. Subsequent implementations may employ multiple connections between the terminal and SUTTAC-Server, with more sophisticated synchronisation.
Interface Switching 53E: In this example, the interface switching 53E is specifically aimed at reducing the cost of 2.5G wireless network access, such as provided by GPRS cellular networks. The interface switching algorithm uses the relatively expensive cellular wireless transport as the lowest priority default transport. It is assumed that the other interfaces provide less expensive, higher bandwidth service. Subsequent implementations may employ an interface policy file to direct switching.

However, the following implementation details are significant for the SUTTAC-Server 1:
Connection Multiplexing/De-multiplexing 66: This is the SUTTAC-Server complement of the terminal multiplexing/de-multiplexing component 56.
Connection Table 67: A table of active TCP connections is used to maintain live connections to target hosts.

In order to make the system available to the general user, the required functionality can be provided as an off-the-shelf solution adapted to cause a server to operate as the SUTTAC-Server 1, and a remote computer as the terminal 3.

An example of this will now be described with reference to FIG. 18, which illustrates the product package 70, containing a GPRS wireless PC card 71, a GPRS over GSM cellular network SIM card 72, a CD-ROM 73 containing installation images of the software, and a user guide 74 containing installation instructions.

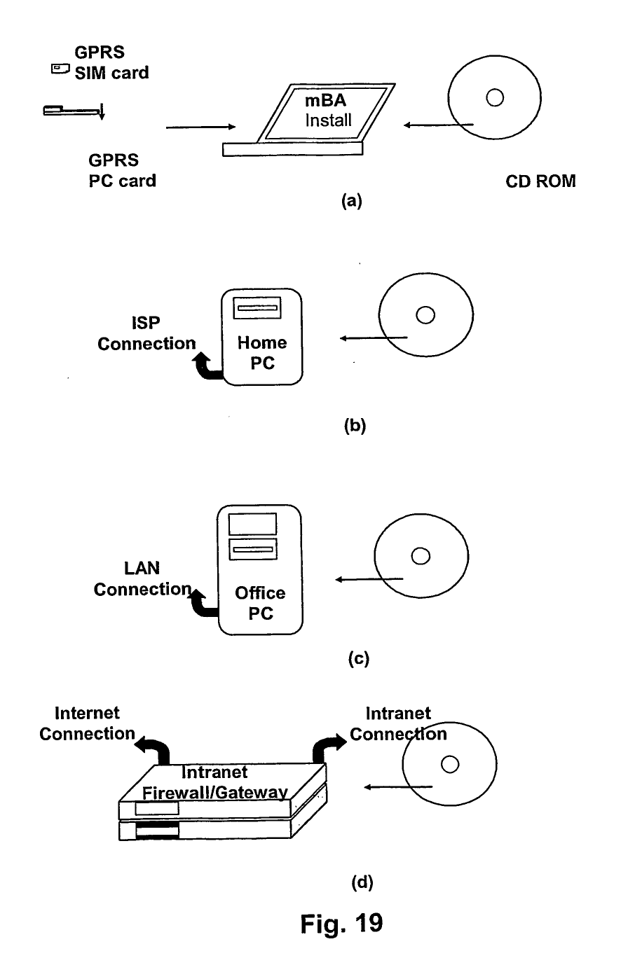

FIG. 19 illustrates the incremental functionality product configuration process. The process consists of the following 4 steps. Step (a) is required for initial product functionality. The remaining steps are optional and may be performed in any order. The installation steps are:
Step (a): Installation of the terminal software on a notebook computer enables the notebook to connect to a public SUTTAC-Server 1 for access to internet services. This access path is illustrated in FIG. 3 for host A. For this type of access the security layer of the protocol stack may be bypassed.
Step (b): Installation of a connection wizard on a personal computer (PC) enables the public SUTTAC-Server to set up a virtual private network connection to the consumer's PC. This access path is illustrated in FIG. 3 for host B. Given this set-up, the consumer is able to securely access private information stored on the personal computer.
Step (c): Installation of a connection wizard on a PC connected to an intranet enables the intranet PC to set up a virtual private network connection to the public SUTTAC-Server. In this case the HTTP protocol that can bypass the corporate firewall is used to carry the encrypted data. This enables the consumer to securely access private information on the intranet PC.
Step (d): Installation of the SUTTAC-Server software on a corporate intranet SUTTAC-Server host computer enables the normal intranet access functionality of the system. This access path is illustrated in FIG. 3 for host C.

Persons skilled in the art will appreciate that numerous variations and modifications will become apparent. All such variations and modifications which become apparent to persons skilled in the art, should be considered to fall within the spirit and scope that the invention broadly appearing before described.

A second embodiment of the invention will be described hereinafter.

Client Features

1. User Authentication

The authentication, similarly to what was described above, asks for username and password to get the connection to the SUTTAC-Server, here a proxy and/or VPN server. Thus, a connection to the VPN server may be established and the application operates with a VPN server.

2. Authorization

Authorization is realized on the SUTTAC-server side because the server authorizes the user to the system and grants the access to the internet/intranet services. The authorization procedure consists of 2 steps:
e) Activation and code verification on the SUTTAC-Server, i.e. comparing the code of the user.
f) Checking of the username/password key pair.
   3. Local Data Security

The local data security is typically achieved by means of the local file system, e.g. NTFS and the respective access is granted depending on the file system permissions and user rights.

4. Cost Management

Access Control (based on the resources location, type and size) may be optional, however is realized in a preferred embodiment of the invention. Cost management is also understood as management of the interface/price priority, dependant if the switching to an interface and setup of routing table is performed. Application programs rely on system TCP/IP stack to connect to outside networks. The corresponding method manages the stack in such manner that the best available network interface is used for all applications and services.

The client GUI indicates clearly which interface is currently selected, and a clear indication of network activity. An Interface switching feature includes an application program relying on a system TCP/IP stack to connect to outside networks. The switching step has to manage the stack in such a way that the best available network interface is used for all the applications. For that purpose the system maintains a list of relative priorities of the interfaces. The initial position of an interface in the list is determined by its cost type. There are four cost types: free, fixed rate, traffic and time rate.

Upon detection of a new interface the terminal makes an educated guess of its cost type based on its nature (LAN/RAS) and keywords in its name. The following sequence is preferred: LAN (WiFi)->Traffic rate, LAN (not recognized)->Fixed rate, RAS (GPRS)->Traffic rate, RAS (not recognized)->Time rate.

The user is asked to confirm/change the cost type and then interfaces are placed below all interfaces of the same type or better cost type. The user may change relative priorities of the interfaces at any time by moving an interface up or down the corresponding list. However, the user is able to switch manually to an interface at any time. This feature protects client applications on the terminal side from disconnection if no network is available for certain time (e.g. 1 hour). The disconnection parameter may be set on the SUTTEC-server side, and is configurable.

The traffic caching/compressing feature is preferably included into cost management. The system makes every attempt to optimize traffic on wireless networks. In most cases these networks (e.g. GPRS) are volume charged. It means that there's a potential to dramatically reduce of customer's costs associated with use of such networks by heavy compression of the communication channel. On the other hand, the latency of these networks is also quite substantial, which means that despite compression/decompression consume certain time the overall transfer time can be decreased.

Compression is based on maintaining synchronized caches of the communication on the both ends of a communication channel. This cache is shared among TCP connections and is persistent. The compression is applied in both directions, but there are two different caches: one for each direction as described more in detail hereinafter. All data that is transmitted through the system is stored in a cache, typically a cyclic buffer, i.e. if the cache is completely filled then the pointer moves to the beginning and cache starts to be filled from the beginning. In case data that is contained in the buffer has to be transmitted the most repeatable number of bytes already in cache is searched and instead of that data the pointers of corresponding positions in the recipients cache is transmitted. Bytes consistencies that may not be found in the cache are transferred as is. This will lead to a first data compression in the sense that reduced data is transmitted. In n an example a cache with a length of 50 characters is stored being filled with following data:

Cache =“<html><head><title></title></head><body></body></h”

Assuming that the following buffer section has to be encoded:

InputBuffer=“<html><body>test</body></html>”

the encoded buffer will look like this:

0,7,1, 0,5,36, 1,4,‘test’, 0,10,41, 0,4,3

This information may be read in the following way:
“0,7,1”—pointer with length of 7 bytes is at 1 st offset
“0,5,36”—pointer with length of 5 bytes is at 36th offset
“1,4,‘test’—literal with length of 4 bytes with ‘test’ value
“0, 10, 41”—pointer with length of 10 at 10th offset
“0, 4, 3”—pointer with length of 4 bytes at 3rd offset

Of course somebody skilled in the art clearly recognized that more effective technologies of encoding may be applied.

Caching/Compression Scheme

Effectiveness of the inventive method depends strongly on the cache size and, because of the potential impossibility to provide a big cache for each connection, the mechanism of synchronous access to the same cache for all connections is implemented. Hence, two sides are implemented—encoder and decoder with the following entities:
a) Cache
   Content—Cache content
   Base—Current pointer position
   Patches—List of patches, which are not glued into cache yet.
   LastAppliedPatch—Encoder: counter for EncoderNo attribute of patch entity. Decoder: number of last received patch
   PatchLevel—cache patch level
b) Patch
   Content—patch content
   EncoderNo—record number in the encoder side
   DecoderNo—record number in the decoder side
   Base—the place where the patch will be applied
c) DataConnectionContext
   PatchLevel—connection patch level

A Patch is formed every time when any part of data comes on an entry point of the encoder. The Content Attribute is filled with base data and EncoderNo is formed from the LastAppliedPatch attribute, which is increased by 1 for each patch. Then the formed patch is applied to the patches list in Cache on the encoder side. To encode the encoder adds at the beginning the information about batch—its size its record number on the encoder side. Encoded data is sent to the socket.

Besides, the encoder watches after the PatchLevel of connection and if PatchLevel of connection is less than PatchLevel of cache, then at the beginning of the encoded data the command is added that the PatchLevel of connection is increased. So on the decoder side is possible to know which cache section was used for the encoding.

To obtain the information about the beginning of the new patch, the decoder reserves the memory for new patch and waits until the whole patch is received. As soon as a patch is completely received, the attribute DecoderNo is set to its number on the decoder side (this number is formed from the LastAppliedPatch attribute). The place where to apply the patch is also chosen on the decoder side and it is equal to the current base in cache and the base in its case is increased by the length of patch. The patch received is applied to the patches list in cache as well as on the encoder side. Finally, through the control connection the confirmation is given that the patch is received with additional DecoderNo and Base attributes.

After having received the confirmation the encoder waits until nobody uses the cache and then rewrites the patch data into the cache and sets the PatchLevel attribute to the value of DecoderNo. Changes on the encoder side are permanent in that way and all connections will use the changed cache already.

On the decoder a more complex method has to be applied. There is a limitation to apply changes into the cache until it is fully clear that all data for encoding, which have been using earlier cache versions, are already encoded. In other words it's not possible to apply a patch into the cache, which has a DecoderNo higher than PatchLevel of any connections but as soon as all PatchLevel of all connections reach DecoderNo or higher we can apply this patch into cache.

The special thread is used on the Decoder side for such purposes. It watches after all DataConnectionContext and if minimal PatchLevel of all becomes more than Cache PatchLevel then all patches are applied into cache with the DecoderNo is less or equal to the minimal PatchLevel of all connections.

Accounting

This embodiment includes, according to the invention an accounting step, representing accounting information for different time frames, e.g Day, Week, Month, Session. Accounting shows the traffic and percentage of compressed incoming/outcoming traffic. If there was no activity for the recent days it just drops to null the representation. The logic on the terminal's side represents the statistics in an intuitive way. A calculator is also available for the traffic calculation. A status pop-up box on ther terminal's GUI shows graphic/iconized representations for: Usage—total data received/sent during a selected time frame (Per session—Daily—Weekly—Monthly), compression performance, data compression rate being achieved (dynamically represented) as a percentage during a selected time frame (real time—daily—weekly—monthly), and the status of connection (e.g. icon to denote which network interface is active or not active). An indicative limit of traffic per month may be set for an interface. If it is present all the usage figures must be compared with it and a warning should be given to the user when he/she reaches the limit.

Logging

Typically, the system contains a logging feature, performing different types of logging dependent on what side they were implemented or called from. Furthermore, system logging (logs the operability and availability of the network interfaces, time switching, namely the switching to another interface and so on) may be included. The user logging logs the connected user and his/her system actions and in addition a server logging performed on the server side and as on the client side assigned by user.

The system tracks any network activity of a client on the terminal's side and logs it for future reference. The information includes client ID, network interface, source and destination address and port number, amount of data transferred, and timestamp. The logs contain access information (timestamp, credentials provided, IP address, name and type of the interface used on the client side, was the access granted, if not, message from the authentication module) and interface switching information (timestamp, client identification, name and type of the new interface).

The SUTTAC-Server in this embodiment includes administration, reporting/statistic, license management and proxy features as described hereinafter.

Administration

This unit provides the functionality for user/group management. The administrator has the possibility to add, remove and modify user/group parameters. Among these parameters are configuration parameters for the terminal (protocols, ports, routing table), personal user data and the like.

Activation key is created for each user at the time of user's creation and it is bound to the certain user. Group management has the same functionality but belonging to one or another group means that they have different access or privileges rights. Administrational tasks are performed by database/filesystem interaction and user/group modifications may be stored in it too.

Reporting/Statistics

This unit maintains reporting/statistics gathering/representing. It means that the administrator has the possibility to gather and browse user/group/SUTTAC-Server information dependent on different parameters, e.g. by JSP/Servlet modules that provide the possibility to retrieve reporting information from the database.

License Management

The system in this embodiment preferably includes a controlled and efficient license management with a unit that maintains the license creation. The license management will typically be located on a separate licensing server. The main purpose of licensing is customer relationship management and security control. License management includes license generating, erasing, or modification for one or for the scope of users. A license may be is issued for a SUTTAC-Server cluster consisting of a number of SUTTAC-Servers, authentication/authorization controller (AA controller) and a local cluster licensing Server. The SUTTAC-Server cluster is uniquely identified by a certificate, which is stored at the global cluster licensing server. A license issued for one SUTTAC-Server cluster is not accepted by any other. For security and control reasons a license has a commencement and expiration date being controlled by the SUTTAC-Server and may furthermore specify a set of features allowed or disallowed for the corresponding SUTTAC-Server cluster.

Proxy

Proxy part is an important communication part between the client system, SUTTAC-Server and the Internet itself. It performs all the necessary compression/synchronization functions with the client side and all service communication functions such as authentication/authorization and activation key verification. It means that proxy supports two kinds of connection—service connection and the data connection itself.

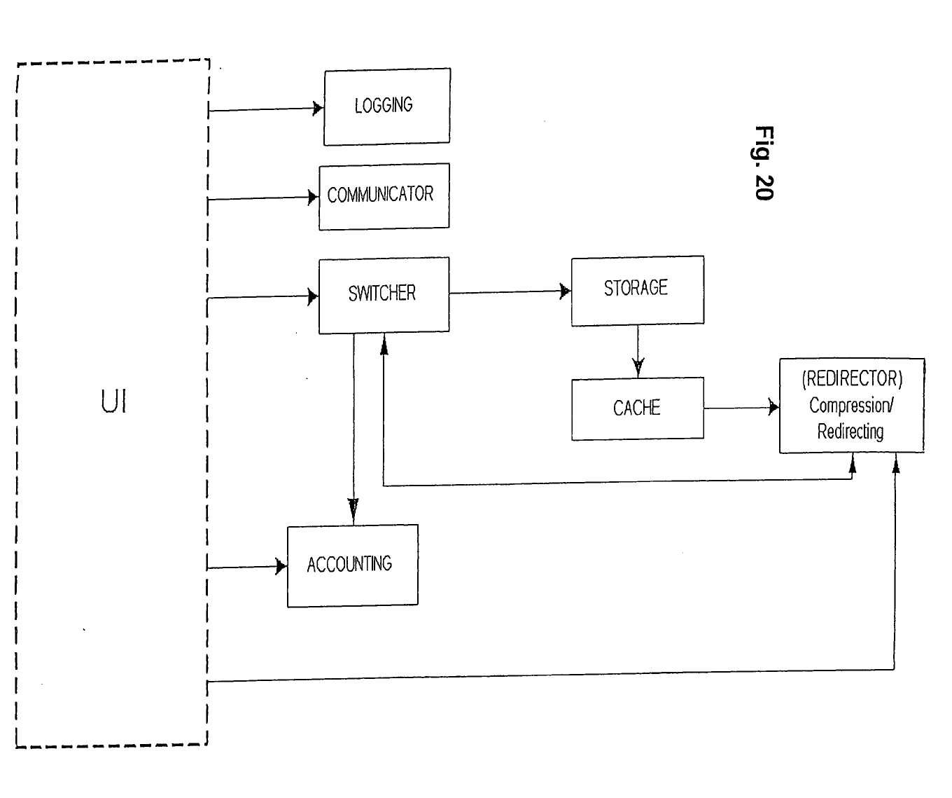

With reference to FIGS. 20 to 22 the inner structure of the terminal and SUTTAC-Server architecture may be understood more in detail. FIG. 20 shows the terminal structure (client).

A user interface (UI) serves as unit for the front-end of the system. It contains forms for entering (choosing) parameters; simple reports initialization, initialization of save/load parameters operation. In this embodiment the UI units is divided into two parts. The first part contains reporting and it communicates with an accounting unit. Thus, it gets the gathered accounting information and represents it in a desirable view for the user. A second part includes the configuration unit, which means that the user communicates with global storage through the configuration part of the UI, in its case if user has made any modifications in configuration it notifies other units about it.

An accounting unit contains the logic of gathering the accounting information from interfaces and other units to represent it to the UI unit in more reliable or suitable format.

A storage unit contains two other subunits. In this embodiment the storage serves as a general storage. It stores all configuration information, user information accounting, interface statistics information and other possible data. The routing table information, which is obtained from the SUTTAC-Server, is stored in the terminal's system registry for redirector accessing.

A so called switcher unit takes care of the routing table setup or in other terms it may be considered as an interface switcher. It communicates directly with the terminal's system registry and storage unit of the terminal unit, which stores the routing information, that came from the SUTTAC-Server, here a proxy server.

A logging unit as described before is a framework, the parts of which are overlapped through all units of the system; it means that each unit uses the logging functionality.

A Redirector unit provides the network connection functionality. It redirects connection streams to the remote communication units. It contains within a subpart a compression feature, which provides the stream compression-caching functionality. The caching/compressing functionality of this unit stores the Internet traffic, and may retrieve the data from it. The cache is synchronizable, i.e. using the compression functionality the local cache is synchronized with server cache.

Finally a Communicator unit handles the control connection events, i.e. user authentication, non-repudiation (server logs client events), cache synchronization and configuration information.

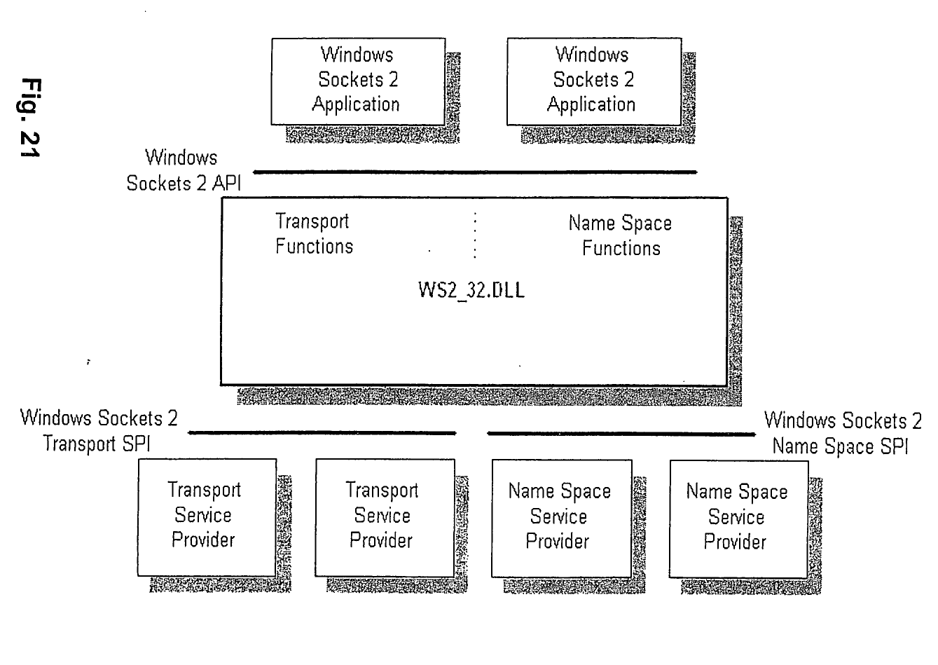

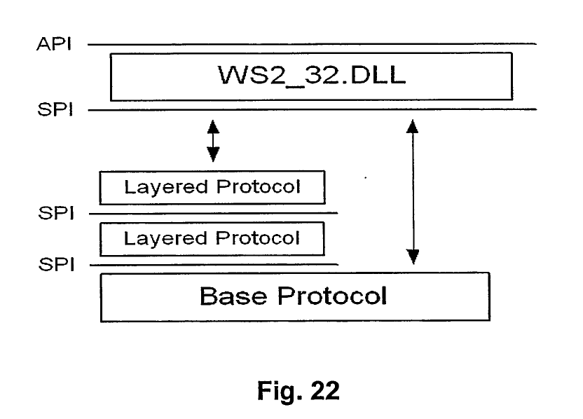

The terminal's TCP stack embedding is shown with reference to a Microsoft® Windows platform in FIGS. 21 and 22. These diagrams show the network OSI layer model. A transport service provider Interface (Windows Sockets SPIs are implemented by transport service providers and name resolution service provider vendors). It means that the system is the Transport SP itself; it extends the transport layer by adding some special interfaces.

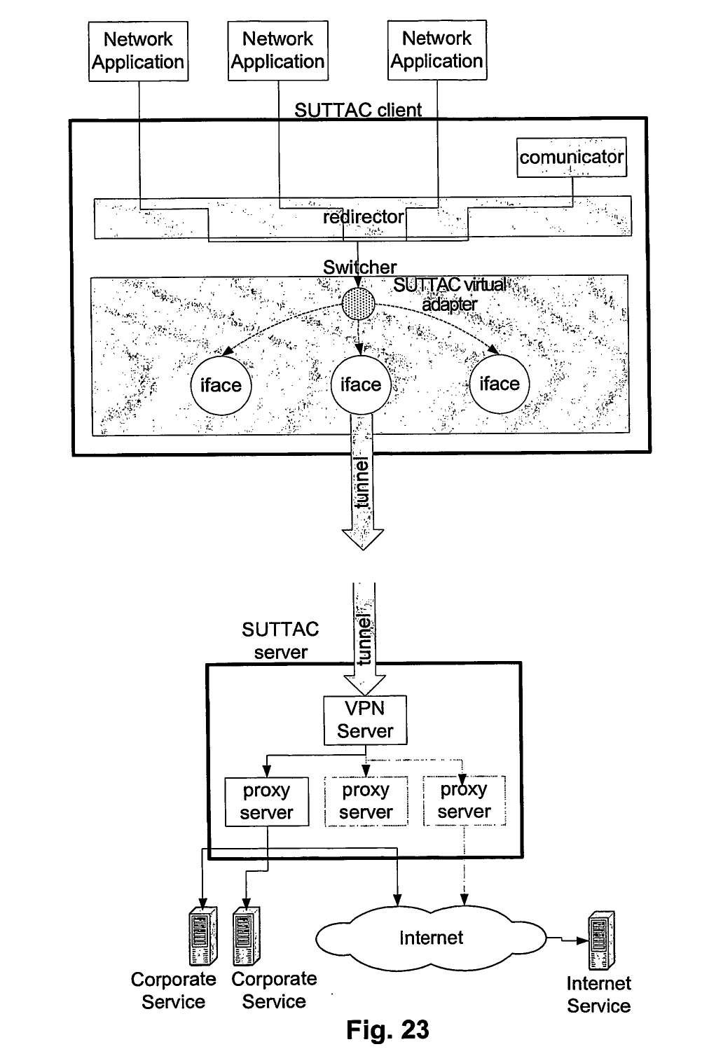

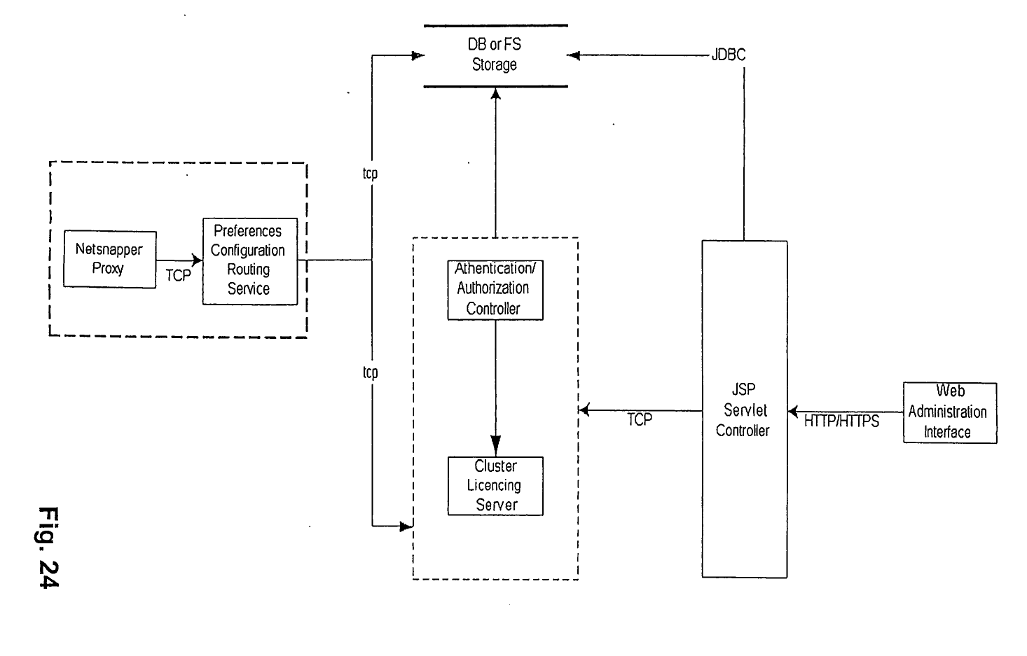

The SUTTAC-Server/Client Structure is shown in FIG. 23 to 25.

Database/File System storage—It is a Postrgre Database storage and it stores different information, such as Authentication Logs, Default Redirect Rules for users, Default Settings for users, SUTTAC-Servers, Group Redirect Rules, User Groups, Interface Switching Logs, Logs Processing, namely Redirect Rules (ports, addresses, bitmasks), Server Settings, Settings (userIDs, compression settings), Statistics Data for SUTTAC-Servers, traffic log, user certificates, user redirect rules and namely users.

Authentication/Authorization module and Cluster Licensing Server (AA and CLS)—these are combined into one logical part for they are using the functionality of each other. These two units are the core part of the SUTTAC-Server system.

JSP/Servlet Controller (JSC)—namely the Servlet based server part that communicates with SUTTAC-Server and DB/FS storage side

Web Administration Interface (WAI)—JSP/HTML based user interface.

Preferences/Configuration/Routing Service (PCRS)—it's an entity to which the client connects at the first time. It configures and verifies client. In future it can be made a separate routing service sort of DHCP.

Proxy—a proxy server instance. As we know there can be many proxy servers in the whole deployment system.

For now PCRS and Proxy are combined in the one proxy facility but it is possible in future to separate them for better deployment.

Complex Dataflow

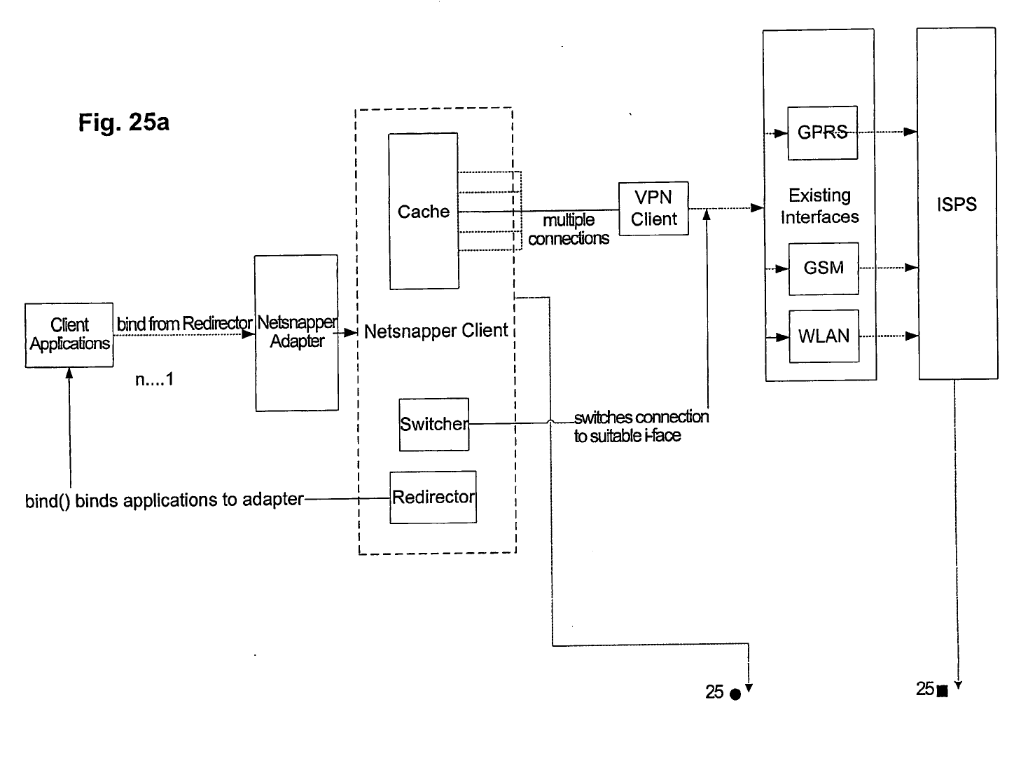

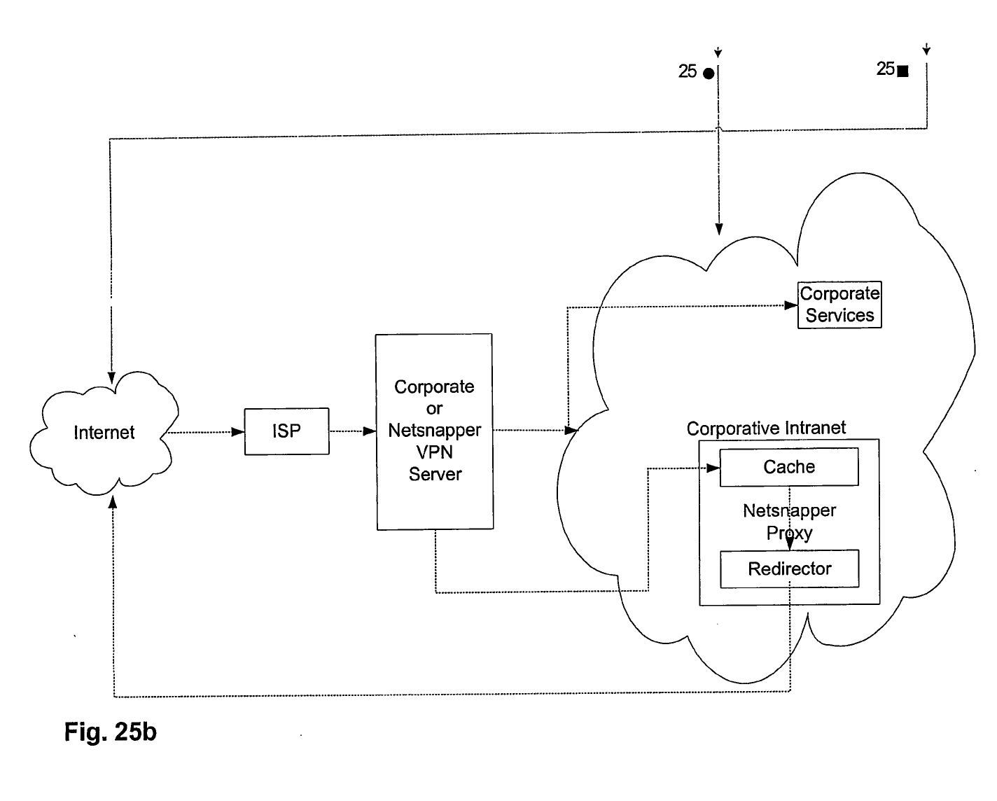

The diagram shown in FIG. 25 represents the complex system infrastructure. It shows how the data flows from very beginning—“client applications” to the very destination—“Internet” or “Corporate Intranet”. A more overview picture is given by FIG. 23.

1. A Server for allowing a user to connect to services using a remote terminal, the Server being coupled to the remote terminal via one of a number of communications links and to the one or more services in use, the Server including:
a) A store for storing device data, the device data including an indication of an identifier for each of a number of predetermined terminals authorised to access the remote services;
b) An authentication system, the authentication system being adapted to:
(i) Obtain an identifier from the terminal; and,
(ii) Compare the identifier of the terminal to the device data; and,
(iii) Establish a connection between the Server and the terminal via at least one of the communication links, in response to the successful comparison;
c) A cache store including:
(i) A first cache adapted to store data transmitted to the terminal; and,
(ii) A second cache adapted to store data received from the terminal; and,
d) A switching system, the switching system being adapted to:
(i) Receive an alternative connection request from the terminal, the alternative connection request indicating that an alternative connection is to be established; and,
(ii) Cooperate with the terminal to establish the alternative connection in response to the request;
e) A security system, the security system being adapted to perform at least one of:
(i) Encoding data to be transmitted to the terminal in accordance with the data stored in the cache store; or,
(ii) Decoding data received from the terminal in accordance with the data stored in the cache store.

2. A Server according to claim 1, the security system being adapted to encode data by compressing and then encrypting the data.

3. A Server according to claim 1 or claim 2, the security system being adapted to decode data by decrypting and then decompressing the data.

4. A Server according to any one of the claims 1 to 3, the terminal having a corresponding cache store, the corresponding cache store being adapted to be identical to the cache store.

5. A Server according to any one of the claims 1 to 4, each cache and corresponding cache being adapted to store predetermined secret data.

6. A Server according to any one of the claims 1 to 5, the security system being adapted to compress the data to be transferred by:
a) Comparing the data to be transferred to the data stored in the first cache; and,
b) Determining matching data in accordance with the results of the comparison;
c) Modifying the data to be transmitted by replacing the matching data with a cache reference, the terminal being adapted to be responsive to the transmitted data to replace the cache references with the matching data from the corresponding first cache.

7. A Server according to any one of the claims 1 to 6, the security system being adapted to decompress data received from the terminal by:
a) Locating cache references in the received data, the cache references being generated by the terminal in accordance with data contained in the corresponding second cache;
b) Accessing the data stored in the second cache;
c) Modifying the received data by replacing the cache references with matching data with a cache store reference, the terminal including a corresponding cache store and being adapted to be responsive to the transmitted data to replace the cache store references with the matching data from the corresponding cache store.

8. A Server according to any one of the claims 1 to 7, the security system being adapted to encrypt/decrypt data the data to be transferred by:
a) Generating an encryption/decryption factor in accordance with the selected data stored in the cache store; and,
b) Encrypting/decrypting the compressed data in accordance with the generated encryption/decryption factor.

9. A Server according to claim 8, the encryption/decryption factor being based on a checksum of the data contained in the first/second cache.

10. A Server according to claim 9, the encryption/decryption factor being used to generate an encryption/decryption key, the key being used in a encryption/decryption algorithm.

11. A Server according to any one of the claims 1 to 10, the cache store system being adapted to select the transmitted data to be stored.

12. A Server according to claim 11, the cache store system being adapted to select the data in accordance with at least one of a number of criteria including:
a) Transmission frequency of the data;
b) The communications link used to transmit the data;
c) The data volume;
d) Any QOS requirements for the data transmission; or,
e) Any priority requirements for the data transmission.

13. A Server according to any one of the claims 1 to 12, the connections links including at least one of:
a) A cellular connection;
b) A short range wireless connection;
c) c) A LAN connection;
d) A fixed line/wired connection; or,
e) An Internet connection.

14. A Server according to any one of the claims 1 to 13, at least one of the communications links being established as a tunnel connection with the terminal.

15. A Server according to any one of the claims 1 to 14, the store being adapted to store user data, the user data including a user identifier for each user authorised to access the remote services, the authentication system being adapted to:
a) Receive a user identifier from the terminal;
b) Compare the user identifier to the user data; and,
c) Establish the connection in response to a successful comparison.

16. A Server according to claim 15, the unique identifier being a username and password.

17. A Server according to claim 15 or claim 16, the authentication system and the switching system being adapted to provide one time authentication such that the unique identifier is not required when an alternative connection is to be established.

18. A Server according to any one of the claims 1 to 17, the cache store including a number of first and second caches, at least one respective first and second cache being used for each terminal adapted to be connected to the Server.

19. A Server according to claim 18, the connection being used to transfer a number of different data types, a respective first and second cache being used for each data type.

20. A Server according to any one of the claims 1 to 19, the Server including a converter, the converter being adapted to receive data having a first form and output data having a second form.

21. A Server according to claim 20, the converter being accepted to receive UDP data from the Internet and transfer the data to the terminal as TCP data.

22. A Server according to any one of the claims 1 to 21, the identifier including a digital signature generated by the terminal in accordance with a respective secret key and predetermined information, the authentication system being adapted to:
a) Determine a public key corresponding to the respective private key from the device data;
b) Decrypt the digital signature using the determined public key; and,
c) Compare the decrypted digital signature with the predetermined information.

23. A Server according to claim 22, the predetermined information being obtained from the cache store.

24. A Server according to any one of the claims 1 to 23, the data being transferred to and from the Server in accordance with an address, the Server including an address system, the address system being adapted to:
a) Determine a first address for the terminal, the first address being defined in accordance with the established connection;
b) Determine a second address for the terminal;
c) Store the first and second addresses in the store; and,
d) Cause the Server to:
(i) Receive data from the services for the terminal in accordance with the second address; and,
(ii) Transfer the data to the terminal in accordance with the first address.

25. A Server according to claim 24, the address system being adapted to:
a) Determine alterations of the first address of the terminal; and,
b) Update the first address stored in the store in accordance with the alterations.

26. A Server according to any one of the claims 1 to 25, the switching system being adapted to:
a) Detect failure of the established connection between the Server and the terminal; or,
b) Maintain any links between the Server and respective services in communication with the terminal until the connection is restored.

27. A Server according to any one of the claims 1 to 26, the Server including a processor, the processor being adapted to implement at least one of:
a) The authentication system;
b) The switching system; or,
c) The security system.

28. A Server according to any one of the claims 1 to 27, the services including:
a) Access to one or more processing systems;
b) Access to one or more communications networks;
c) Access to one or more databases; and,
d) The Internet.

29. A terminal adapted to communicate with a Server for allowing a user to connect to services, the terminal being coupled to the Server via one of a number of communications links and to the one or more services in use, the terminal including:
a) A store for storing device data, the device data including an indication of an identifier for the terminal;
b) An authentication system, the authentication system being adapted to:
(i) Generate an identifier in accordance with the device data; and,
(ii) Transfer the identifier to the Server, the Server responding to the identifier to determine if the terminal is authorised to access the remote services and, establish a connection between the Server and the terminal via at least one of the communication links, in response to the successful determination;
c) A cache store including:
(i) A first cache adapted to store data transmitted to the terminal; and,
(ii) A second cache adapted to store data received from the terminal;
d) A switching system, the switching system being adapted to:
(i) Determine if an alternative connection can be established via one or more alternative communications links;
(ii) Compare the alternative connection to the existing connection; and,
(iii) Transfer an alternative connection request to the Server;
(iv) Cooperate with the Server to establish the alternative connection; and,
e) A security system, the security system being adapted to perform at least one of:
(i) Encoding data to be transmitted to the Server in accordance with the data stored in the cache store; or,
(ii) Decoding data received from the Server in accordance with the data stored in the cache store.

30. A terminal according to claim 29, the terminal being adapted to communicate with the Server of any one of the claims 1 to 28.

31. A terminal according to claim 29 or claim 30, the Server having a corresponding cache store, the corresponding cache store being adapted to be identical to the cache store.

32. A terminal according to any one of the claims 29 to 31, each cache and corresponding cache being adapted to store predetermined secret data.

33. A terminal according to any one of the claims 29 to 32, the terminal being adapted to compare the alternative connection to the existing connection by comparing at least one of:
a) The connection bandwidth;
b) The connection cost;
c) The connection speed; or,
d) A connection reliability.

34. A terminal according to any one of the claims 29 to 33, the security system being adapted to compress the data to be transferred by:
a) Comparing the data to be transferred to the data stored in the first cache; and,
b) Determining matching data in accordance with the results of the comparison;
c) Modifying the data to be transmitted by replacing the matching data with a cache reference, the Server being adapted to be responsive to the transmitted data to replace the cache references with the matching data from the corresponding first cache.

35. A terminal according to any one of the claims 29 to 34, the security system being adapted to decompress data received from the Server by:
a) Locating cache references in the received data, the cache references being generated by the Server in accordance with data contained in the corresponding second cache;
b) Accessing the data stored in the second cache;
c) Modifying the received data by replacing the cache references with matching data with a cache store reference, the terminal including a corresponding cache store and being adapted to be responsive to the transmitted data to replace the cache store references with the matching data from the corresponding cache store.

36. A terminal according to any one of the claims 29 to 35, the security system being adapted to encrypt/decrypt data the data to be transferred by:
a) Generating an encryption/decryption factor in accordance with the selected data stored in the cache store; and,
b) Encrypting/decrypting the compressed data in accordance with the generated encryption/decryption factor.

37. A terminal according to claim 36, the encryption/decryption factor being based on a checksum of the data contained in the first/second cache.

38. A terminal according to claim 37, the encryption/decryption factor being used to generate an encryption/decryption key, the key being used in a encryption/decryption algorithm.

39. A terminal according to any one of the claims 29 to 38, the cache store system being adapted to select the transmitted data to be stored.

40. A terminal according to claim 39, the cache store system being adapted to select the data in accordance with at least one of a number of criteria including:
a) Transmission frequency of the data;
b) The communications link used to transmit the data;
c) The data volume;
d) Any QOS requirements for the data transmission; or,
e) Any priority requirements for the data transmission. A

41. A terminal according to any one of the claims 29 to 40, the connections links including at least one of:
a) A cellular connection;
b) A short range wireless connection;
c) A LAN connection;
d) A fixed/wired connection; or,
e) An Internet connection.

42. A terminal according to any one of the claims 29 to 41, at least one of the communications links being established as a tunnel connection with the terminal.

43. A system for allowing a user to connect to services using a remote terminal coupled to a Server via one of a number of communications links, the Server being coupled to the one or more services in use, the system including a Server according to any one of the claims 1 to 28, and a terminal according to any one of the claims 29 to 42.

44. A method of allowing a user to connect to services using a terminal coupled to a Server via one of a number of communications links, the Server being coupled to the one or more services in use, the method including causing the Server to:
a) Authenticate the terminal by:
(i) Obtaining an identifier from the terminal; and,
(ii) Comparing the identifier of the terminal to device data, the device data being stored in a store, the device data including an indication of an identifier for each of a number of predetermined terminals authorised to access the remote services; and,
(iii) Establishing a connection between the Server and the terminal via at least one of the communication links, in response to the successful comparison;
b) Store data in a respective cache store, the cache store including:
(i) A first cache adapted to store data transmitted to the terminal; and,
(ii) A second cache adapted to store data received from the terminal; and,
c) Operate to switch the connection by:
(i) Determining if an alternative connection can be established via one or more alternative communications links;
(ii) Comparing the alternative connection to the existing connection; and,
(iii) Establishing the alternative connection in response to a successful comparison;
d) Secure the data by performing at least one of:
(i) Encoding data to be transmitted to the terminal in accordance with the data stored in the cache store; or,
(ii) Decoding data received from the terminal in accordance with the data stored in the cache store.

45. A method according to claim 44, the method including causing the Server to operate as a Server according to any one of the claims 1 to 28.

46. A method of allowing a user to connect to services using a terminal coupled to a Server via one of a number of communications links, the Server being coupled to the one or more services in use, the method including causing the terminal to:
a) Participate in authentication by:
(i) Generating an identifier in accordance with device data, the device data including an indication of an identifier for the terminal;
(ii) Transfer the identifier to the Server, the Server responding to the identifier to determine if the terminal is authorised to access the remote services and, establish a connection between the Server and the terminal via at least one of the communication links, in response to the successful determination;
b) Store data in a respective cache store, the cache store including:
(i) A first cache adapted to store data transmitted to the terminal; and,
(ii) A second cache adapted to store data received from the terminal; and,
c) Operate to switch the connection by:
(i) Determining if an alternative connection can be established via one or more alternative communications links;
(ii) Comparing the alternative connection to the existing connection; and,
(iii) Transferring an alternative connection request to the Server;
(iv) Cooperating with the Server to establish the alternative connection; and,
d) Secure the data by performing at least one of:
(i) Encoding data to be transmitted to the Server in accordance with the data stored in the cache store; or,
(ii) Decoding data received from the Server in accordance with the data stored in the cache store.

47. A method according to claim 46, the method including causing the terminal to operate as a terminal according to any one of the claims 29 to 43.
